(19) United States
(12) Patent Application Publication
(10) Pub. No.: US 2019/0071604 A1
(43) Pub. Date: Mar. 7, 2019

(54) LIQUID CRYSTAL CURED FILM AND METHOD FOR MANUFACTURING SAME

(71) Applicant: ZEON CORPORATION, Chiyoda-ku, Tokyo (JP)

(72) Inventors: Shunpei NAKAJIMA, Tokyo (JP); Akira IKEDA, Tokyo (JP); Manabu ITO, Tokyo (JP)

(73) Assignee: ZEON CORPORATION, Chiyoda-ku, Tokyo (JP)

(21) Appl. No.: 16/084,692

(22) PCT Filed: Mar. 9, 2017
(86) PCT No.: PCT/JP2017/009542

§ 371 Date: Sep. 13, 2018

(30) Foreign Application Priority Data
Mar. 28, 2016 (JP) 2016-064047

(51) Int. Cl. C09K 19/04; C09K 19/54; G02F 1/13363; G02F 1/1335

(52) U.S. Cl. CPC C09K 19/04; C09K 19/54; G02F 1/133634; G02F 1/133528; C09K 2019/0448; G02F 2001/133541; G02F 2001/133543; G02F 2001/133548; G02F 2001/133631

(57) ABSTRACT

A liquid crystal cured film includes a liquid crystal cured layer formed of a cured product of a liquid crystal composition containing a polymerizable liquid crystal compound capable of expressing birefringence with reverse wavelength distribution, the polymerizable liquid crystal compound containing an ethylenically unsaturated bond and an aromatic ring. The film satisfies 1.00<X(S)/X(A), where X(S) represents a peak ratio X of one surface of the liquid crystal cured layer; X(A) is a peak ratio X of the other surface of the liquid crystal cured layer; the peak ratio X is a ratio represented by X=I(1)/I(2); I(1) is a peak strength derived from in-plane deformation vibration of the ethylenically unsaturated bond in measurement of infrared total reflection-absorption spectrum; and I(2) is a peak strength derived from stretching vibration of an unsaturated bond of the aromatic ring in measurement of infrared total reflection-absorption spectrum.

### FIELD

The present invention relates to a liquid crystal cured film including a liquid crystal cured layer and a method for producing the same.

### BACKGROUND

As a method for producing an optical film, a method using a liquid crystal compound has been conventionally used. In this method, an optical film including a liquid crystal cured layer formed of a cured product of a liquid crystal composition is usually obtained by applying the liquid crystal composition containing a liquid crystal compound onto an appropriate substrate and curing the applied liquid crystal composition (see Patent Literature 1). In recent years, attention has been attracted to a liquid crystal compound capable of expressing birefringence with reverse wavelength distribution as the liquid crystal compound described above (see Patent Literature 2).

### CITATION LIST

### Patent Literature

Patent Literature 1: Japanese Patent Application Laid-Open No. 2015-143786 A

Patent Literature 2: Japanese Patent Application Laid-Open No. 2015-111257 A

### SUMMARY

### Technical Problem

In the optical film produced by the aforementioned prior-art production method, a surface on a substrate side of the liquid crystal cured layer is protected by the substrate. On the other hand, a surface on an air side of the liquid crystal cured layer is usually exposed. Therefore, the surface on the air side of the liquid crystal cured layer would be scratched during operation such as winding of the optical film and conveyance. If the scratch occurs, the haze of the liquid crystal cured layer may be increased to cause failure in obtaining desired optical properties.

The present invention has been made in view of the aforementioned problems. An object of the present invention is to provide a liquid crystal cured film including a liquid crystal cured layer having excellent scratch resistance and a method for producing the same.

### Solution to Problem

The present invention is as follows:

(1) A liquid crystal cured film comprising a liquid crystal cured layer formed of a cured product of a liquid crystal composition containing a polymerizable liquid crystal compound capable of expressing birefringence with reverse wavelength distribution, the polymerizable liquid crystal compound containing an ethylenically unsaturated bond and an aromatic ring, wherein

the following expression (i) is satisfied:

1.00<X(S)/X(A) (i)

(in the expression (i),

X(S) represents a peak ratio X of one surface of the liquid crystal cured layer,

X(A) is a peak ratio X of the other surface of the liquid crystal cured layer,

the peak ratio X is a ratio represented by X=I(1)/I(2),

I(1) is a peak strength derived from in-plane deformation vibration of the ethylenically unsaturated bond in measurement of infrared total reflection-absorption spectrum, and

I(2) is a peak strength derived from stretching vibration of an unsaturated bond of the aromatic ring in measurement of infrared total reflection-absorption spectrum.).

(2) The liquid crystal cured film according to (1), wherein the liquid crystal cured layer has a retardation with reverse wavelength distribution.
(3) The liquid crystal cured film according to (1) or (2), wherein

the liquid crystal composition contains a surfactant, and

an amount of the surfactant on the one surface of the liquid crystal cured layer is smaller than an amount of the surfactant on the other surface of the liquid crystal cured layer.

(4) The liquid crystal cured film according to any one of (1) to (3), wherein the polymerizable liquid crystal compound contains a main chain mesogen and a side chain mesogen bonded to the main chain mesogen in a molecule of the polymerizable liquid crystal compound.
(5) The liquid crystal cured film according to any one of (1) to (4), wherein the polymerizable liquid crystal compound is represented by the following formula (I):

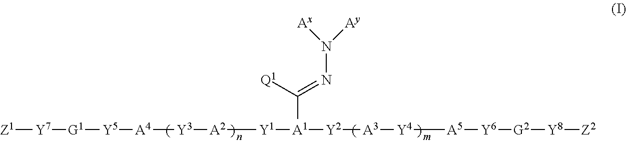

(in the formula (I),

Y¹ to Y⁸ each independently represent a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—, where R¹ represents a hydrogen atom or an alkyl group of 1 to 6 carbon atoms,

G¹ and G² each independently represent a divalent aliphatic group of 1 to 20 carbon atoms optionally having a substituent, wherein the aliphatic group may contain one or more per aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein, with a proviso that cases where two or more —O— or —S— groups are inserted adjacently to each other are excluded, and wherein R² represents an alkyl group of 1 to 6 carbon atoms,

Z¹ and Z² each independently represent an alkenyl group of 2 to 10 carbon atoms optionally substituted with a halogen atom,

A^{x} represents an organic group of 2 to 30 carbon atoms having at least one aromatic ring selected from the group consisting of an aromatic hydrocarbon ring and an aromatic heterocyclic ring,

A^{y} represents a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms containing at least one aromatic ring selected from the group consisting of an aromatic hydrocarbon ring and an aromatic heterocyclic ring, where R³ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms, R⁴ represents an alkyl group of 1 to 20 carbon atoms, an alkenyl group of 2 to 20 carbon atoms, a phenyl group, or a 4-methylphenyl group, R⁹ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent, the aromatic ring contained in the A^{x} and A^{y} may have a substituent, and the A^{x} and A^{y} may form a ring together,

A¹ represents a trivalent aromatic group optionally having a substituent,

A² and A³ each independently represent a divalent alicyclic hydrocarbon group of 3 to 30 carbon atoms optionally having a substituent,

A⁴ and A⁵ each independently represent a divalent aromatic group of 6 to 30 carbon atoms optionally having a substituent,

Q¹ represents a hydrogen atom or an alkyl group of 1 to 6 carbon atoms optionally having a substituent, and

m and n each independently represent 0 or 1.).

(6) The liquid crystal cured film according to any one of (1) to (5), wherein the polymerizable liquid crystal compound contains at least one selected from the group consisting of a benzothiazole ring, and a combination of a cyclohexyl ring and a phenyl ring, in a molecule of the polymerizable liquid crystal compound.
(7) A method for producing the liquid crystal cured firm according to any one of (1) to (6), comprising the steps of:

forming a layer of the liquid crystal composition on a substrate film; and

curing the layer of the liquid crystal composition to obtain the liquid crystal cured layer.

### Advantageous Effects of Invention

The present invention can provide a liquid crystal cured film including a liquid crystal cured layer having excellent scratch resistance and a method for producing the same.

### BRIEF DESCRIPTION OF DRAWINGS

FIG. 1 is a cross-sectional view schematically illustrating a liquid crystal cured film according to an embodiment of the present invention.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a direction of an element being “parallel” and “perpendicular” may allow an error within the range of not impairing the advantageous effects of the present invention, for example, within a range of ±5°, preferably within a range of ±3°, and more preferably within a range of ±1°, unless otherwise specified.

In the following description, a retardation of a certain layer refers to an in-plane retardation Re, unless otherwise specified. The in-plane retardation Re is a value represented by Re=(nx−ny)×d, unless otherwise specified. Herein, nx represents a refractive index in a direction which gives, among directions perpendicular to the thickness direction of the layer (in-plane directions), the maximum refractive index. ny represents a refractive index in a direction, among the above-mentioned in-plane directions of the layer, orthogonal to the direction giving nx. d represents the thickness of the layer. The measurement wavelength of the retardation is 590 nm unless otherwise specified.

In the following description, the direction of a slow axis of a certain layer refers to a direction of the slow axis of the in-plane directions of the layer, unless otherwise specified.

In the following description, a resin having a positive intrinsic birefringence value means a resin of which a refractive index in a stretching direction is larger than a refractive index in a direction orthogonal to the stretching direction. A resin having a negative intrinsic birefringence value means a resin of which the refractive index in the stretching direction is smaller than the refractive index in the direction orthogonal to the stretching direction. The intrinsic birefringence value may be calculated from dielectric constant distribution.

In the following description, “polarizing plate” and “wave plate” are used as terms including a flexible film and sheet such as a resin film, unless otherwise specified.

[1. Summary of Liquid Crystal Cured Film]

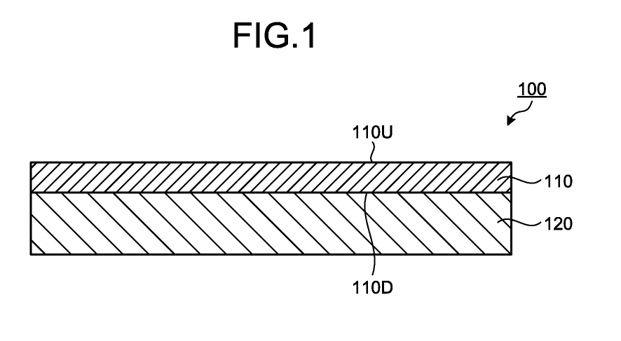

FIG. 1 is a cross-sectional view schematically illustrating a liquid crystal cured film 100 according to an embodiment of the present invention. As illustrated in FIG. 1, the liquid crystal cured film 100 includes a liquid crystal cured layer 110 formed of a cured product of a liquid crystal composition containing a polymerizable liquid crystal compound capable of expressing birefringence with reverse wavelength distribution. In the following description, the polymerizable liquid crystal compound capable of expressing birefringence with reverse wavelength distribution may be referred to as “polymerizable liquid crystal compound with reverse wavelength distribution” as appropriate. In the liquid crystal cured layer 110, a compound containing an ethylenically unsaturated bond and an aromatic ring in the molecular structure is used as the polymerizable liquid crystal compound with reverse wavelength distribution.

The liquid crystal cured layer 110 satisfies the following expression (i):

1.00<X(S)/X(A) (i)

(In the expression (i),

X(S) represents a peak ratio X of one surface 110D (in FIG. 1, a surface on a substrate film side) of the liquid crystal cured layer 110,

X(A) represents a peak ratio X of another surface 110U (in FIG. 1, a surface on an air side) of the liquid crystal cured layer 110,

the peak ratio X is a ratio represented by X=I(1)/I(2),

I(1) is a peak strength derived from in-plane deformation vibration of the ethylenically unsaturated bond in measurement of infrared total reflection-absorption spectrum, and

I(2) is a peak strength derived from stretching vibration of an unsaturated bond of the aromatic ring in measurement of infrared total reflection-absorption spectrum.)

In the following description, the “infrared total reflection-absorption spectrum” may be referred to as “IR spectrum” as appropriate.

The significance of the expression (i) will be described. The cured product of the liquid crystal composition contained in the liquid crystal cured layer 110 is usually a cured product obtained by polymerizing the polymerizable liquid crystal compound with reverse wavelength distribution contained in the liquid crystal composition. Therefore, the cured product contains a polymer of the polymerizable liquid crystal compound with reverse wavelength distribution. In general, it is difficult to achieve a complete reaction of polymerization of a polymerizable liquid crystal compound. Therefore, the cured product may contain the polymerizable liquid crystal compound with reverse wavelength distribution as a residual monomer. During the curing of the liquid crystal composition, the ethylenically unsaturated bond of the polymerizable liquid crystal compound with reverse wavelength distribution disappears by a polymerization reaction. However, the unsaturated bond of the aromatic ring does not react, and therefore, the unsaturated bond does not disappear. Therefore, the ratio X of the peak strength I(1) relative to the peak strength I(2) shows a residual ratio of the ethylenically unsaturated bond in the liquid crystal cured layer 110, that is, the ratio of the polymerizable liquid crystal compound with reverse wavelength distribution as the residual monomer in the liquid crystal cured layer 110. Accordingly, the peak ratio X can quantitatively represent a degree of progression of the polymerization reaction of the polymerizable liquid crystal compound with reverse wavelength distribution.

The expression (i) represents that the polymerization reaction of the polymerizable liquid crystal compound with reverse wavelength distribution on the other surface 110U proceeds more largely than on the surface 110D of the liquid crystal cured layer 110. Therefore, the hardness of the surface 110U of the liquid crystal cured layer 110 can be increased, and thus, the scratch resistance of the liquid crystal cured layer 110 can be improved.

The scratch resistance of the liquid crystal cured layer 110 can be evaluated by a rubbing test. Specifically, the haze of the liquid crystal cured film 100 is measured, the rubbing test in which the surface 110U of the liquid crystal cured layer 110 is rubbed is performed, and the haze of the liquid crystal cured film 100 after the rubbing test is then measured. The amount of change in haze before and after the rubbing test is calculated. Smaller amount of the haze change can be evaluated as a better scratch resistance of the liquid crystal cured layer 110.

The liquid crystal cured film 100 may include only the liquid crystal cured layer 110. Alternatively, the liquid crystal cured film 100 may include an optional layer in combination with the liquid crystal cured layer 110. For example, the liquid crystal cured film 100 may include a substrate film 120 used in formation of the liquid crystal cured layer 110 as an optional layer in combination with the liquid crystal cured layer 110. The liquid crystal cured film 100 including such a substrate film 120 can have a high hardness of the surface 110U on the air side as illustrated in FIG. 1, and thereby can have an improved scratch resistance.

According to the aforementioned liquid crystal cured film 100, the following advantages can be usually obtained.

In general, a liquid crystal cured film including a liquid crystal cured layer may be used in a form in which the liquid crystal cured layer is bonded to an optional optical member by using an appropriate adhesive. In such a case, as the adhesive, an ultraviolet-curable adhesive is often used. In a prior-art liquid crystal cured film, when a liquid crystal cured layer is brought into contact with an adhesive, the retardation of the liquid crystal cured layer may be changed, and desired optical properties may become unavailable.

On the other hand, the liquid crystal cured layer 110 of the liquid crystal cured film 100 according to the embodiment has excellent adhesive resistance. Therefore, when the liquid crystal cured layer 110 is brought into contact with the adhesive, change in retardation of the liquid crystal cured layer can be suppressed. According to investigation by the present inventors, it has been found out that, in general, reduction in the amount of the residual monomer in the liquid crystal cured layer can improve adhesive resistance of the liquid crystal cured layer. Regarding the liquid crystal cured film 100 according to this embodiment, reduction in the amount of the residual monomer on the surface 110U of the liquid crystal cured layer 110 resulted in achievement of excellent adhesive resistance on the surface 110U.

The adhesive resistance of the liquid crystal cured layer 110 may be evaluated by the following method.

The in-plane retardation Re₀ of the liquid crystal cured film 100 at a measurement wavelength of 590 nm is measured. Subsequently, an ultraviolet-curable adhesive is applied onto the surface 110U of the liquid crystal cured layer 110 so that the thickness of the adhesive is 100 μm or more, to obtain a layered body including the substrate film, the liquid crystal cured layer, and an adhesive layer. Five minutes after the time point of applying the adhesive onto the liquid crystal cured layer, the in-plane retardation Re₁ of the layered body at a measurement wavelength of 590 nm is measured. The amount ΔRe of change in in-plane retardation due to the coating of the adhesive is calculated by the following expression (ii).

ΔRe={(Re₀−Re₁)/Re₀}×100(%) (ii)

Smaller absolute value of in-plane retardation changing amount ΔRe thus obtained is indicative of better resistance to the adhesive of the liquid crystal cured layer 110.

When the liquid crystal cured film 100 includes the liquid crystal cured layer 110 and the substrate film 120, usually the substrate film 120 can be easily peeled off. As described above, the degree of progression of the polymerization reaction of the polymerizable liquid crystal compound with reverse wavelength distribution on the surface 110D on the substrate side of the liquid crystal cured layer 110 is smaller than that on the surface 110U on the air side thereof. The adhesion force between the liquid crystal cured layer 110 and the substrate film 120 is thus small. Therefore, the peeling properties of the substrate film 120 can be improved, as described above.

In particular, good peeling properties of the substrate film 120 together with achievement of favorable scratch resistance of the liquid crystal cured layer 110 is an advantageous effect that could not be achieved by the prior-art techniques such as the technique disclosed in Patent Literature 1. In Patent Literature 1, the progression of the polymerization reaction on the surface on the air side of the liquid crystal cured layer is suppressed for enhancing the adhesion force of the adhesive on the surface on the air side of the liquid crystal cured layer, to thereby facilitate peeling of the substrate film. However, in the liquid crystal cured layer in Patent Literature 1, the hardness of the surface on the air side is decreased, and it is difficult to improve the scratch resistance thereof. In contrast, regarding the liquid crystal cured film 100 according to this embodiment, while the hardness of the surface 110U on the air side of the liquid crystal cured layer is increased, the peeling properties of the substrate film 120 can be improved. Therefore, both the scratch resistance and the peeling properties can be improved.

[2. Polymerizable Liquid Crystal Compound with Reverse Wavelength Distribution]

The polymerizable liquid crystal compound with reverse wavelength distribution has liquid crystal properties. Therefore, when the polymerizable liquid crystal compound with reverse wavelength distribution is oriented, a liquid crystal phase may be exhibited. The polymerizable liquid crystal compound with reverse wavelength distribution has polymerizability. Therefore, when the polymerizable liquid crystal compound with reverse wavelength distribution is polymerized in a state wherein the liquid crystal phase is exhibited as described above, the compound may form a polymer with orientation of molecules in the liquid crystal phase being maintained.

Further, the polymerizable liquid crystal compound with reverse wavelength distribution is a compound capable of expressing birefringence with reverse wavelength distribution. Herein, the compound capable of expressing birefringence with reverse wavelength distribution refers to a compound the polymer of which obtained in accordance with the aforementioned manner expresses birefringence with reverse wavelength distribution.

The birefringence with reverse wavelength distribution refers to birefringence in which a birefringence Δn(450) at a wavelength of 450 nm and a birefringence Δn(650) at a wavelength of 650 nm satisfy the following expression (iii). The polymerizable liquid crystal compound with reverse wavelength distribution capable of expressing such birefringence with reverse wavelength distribution may usually express larger birefringence as the measurement wavelength is longer. Therefore, the birefringence of the polymer obtained by polymerizing the polymerizable liquid crystal compound with reverse wavelength distribution in accordance with the aforementioned manner usually satisfies the following expression (iv). In the following expression (iv), Δn(550) represents a birefringence at a measurement wavelength of 550 nm.

Δn(450)<Δn(650) (iii)

Δn(450)<Δn(550)<Δn(650) (iv)

As the polymerizable liquid crystal compound with reverse wavelength distribution, for example, a compound having a main chain mesogen and a side chain mesogen bonded to the main chain mesogen in the molecule of the polymerizable liquid crystal compound with reverse wavelength distribution may be used. In a state wherein the polymerizable liquid crystal compound with reverse wavelength distribution having the main chain mesogen and the side chain mesogen is oriented, the side chain mesogen may be oriented in a direction different from that of the main chain mesogen. Therefore, the main chain mesogen and the side chain mesogen may be oriented in different directions in the polymer obtained by polymerizing the polymerizable liquid crystal compound with reverse wavelength distribution with such orientation being maintained. In this case, the birefringence is expressed as a difference between the refractive index corresponding to the main chain mesogen and the refractive index corresponding to the side chain mesogen. Therefore, the polymerizable liquid crystal compound with reverse wavelength distribution and a polymer thereof can express birefringence with reverse wavelength distribution.

For example, the polymerizable liquid crystal compound with reverse wavelength distribution, such as the compound having the main chain mesogen and the side chain mesogen, usually has a specific steric structure that is different from the steric structure of a general polymerizable liquid crystal compound with forward wavelength distribution. Herein, the “polymerizable liquid crystal compound with forward wavelength distribution” refers to a polymerizable liquid crystal compound capable of expressing birefringence with forward wavelength distribution. The birefringence with forward wavelength distribution represents birefringence of which the absolute value is smaller as the measurement wavelength is longer. It is deduced that such a specific steric structure of the polymerizable liquid crystal compound with reverse wavelength distribution can be one of factors causing the effect of the present invention.

In the present invention, a compound containing an ethylenically unsaturated bond and an aromatic ring in the molecular structure is used as the polymerizable liquid crystal compound with reverse wavelength distribution. Since the polymerizable liquid crystal compound with reverse wavelength distribution contains an ethylenically unsaturated bond and an aromatic ring, the degree of progression of the polymerization reaction can be quantified by using the peak ratio X in the liquid crystal cured layer.

The molecular weight of the polymerizable liquid crystal compound with reverse wavelength distribution is preferably 300 or more, more preferably 700 or more, and particularly preferably 1,000 or more, and is preferably 2,000 or less, more preferably 1,700 or less, and particularly preferably 1,500 or less. When the polymerizable liquid crystal compound with reverse wavelength distribution has the aforementioned molecular weight, this means that the polymerizable liquid crystal compound with reverse wavelength distribution is a monomer.

By using the polymerizable liquid crystal compound with reverse wavelength distribution as being not a polymer but a monomer, the liquid crystal composition can have particularly favorable application properties.

As the polymerizable liquid crystal compound with reverse wavelength distribution, one type thereof may be solely used, and two or more types thereof may also be used in combination at any ratio.

Examples of the polymerizable liquid crystal compound with reverse wavelength distribution may include those described in Japanese Patent Application Laid-Open No. 2014-123134 A.

Examples of the polymerizable liquid crystal compound with reverse wavelength distribution may include a compound represented by the following formula (Ia). In the following description, the compound represented by the formula (Ia) is sometimes appropriately referred to as a “compound (Ia)”.

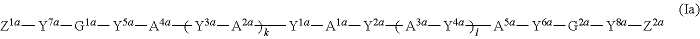

In the above-described formula (Ia), A^{1a} represents an aromatic hydrocarbon ring group having as a substituent an organic group of 1 to 67 carbon atoms having at least one aromatic ring selected from the group consisting of an aromatic hydrocarbon ring and an aromatic heterocyclic ring; or an aromatic heterocyclic ring group having as a substituent an organic group of 1 to 67 carbon atoms having at least one aromatic ring selected from the group consisting of an aromatic hydrocarbon ring and an aromatic heterocyclic ring.

Specific examples of A^{1a} may include: a phenylene group substituted with a group represented by a formula: —R^{f}C(═N—NR^{g}R^{h}) or formula: —R^{f}C(═N—N═R^{f1}R^{h}); a benzothiazole-4,7-diyl group substituted with a 1-benzofuran-2-yl group; a benzothiazole-4,7-diyl group substituted with a 5-(2-butyl)-1-benzofuran-2-yl group; a benzothiazole-4,7-diyl group substituted with a 4,6-dimethyl-1-benzofuran-2-yl group; a benzothiazole-4,7-diyl group substituted with a 6-methyl-1-benzofuran-2-yl group; a benzothiazole-4,7-diyl group substituted with a 4,6,7-trimethyl-1-benzofuran-2-yl group; a benzothiazole-4,7-diyl group substituted with a 4,5,6-trimethyl-1-benzofuran-2-yl group; a benzothiazole-4,7-diyl group substituted with a 5-methyl-1-benzofuran-2-yl group; a benzothiazole-4,7-diyl group substituted with a 5-propyl-1-benzofuran-2-yl group; a benzothiazole-4,7-diyl group substituted with a 7-propyl-1-benzofuran-2-yl group; a benzothiazole-4,7-diyl group substituted with a 5-fluoro-1-benzofuran-2-yl group; a benzothiazole-4,7-diyl group substituted with a phenyl group; a benzothiazole-4,7-diyl group substituted with a 4-fluorophenyl group; a benzothiazole-4,7-diyl group substituted with a 4-nitrophenyl group; a benzothiazole-4,7-diyl group substituted with a 4-trifluoromethylphenyl group; a benzothiazole-4,7-diyl group substituted with a 4-cyanophenyl group; a benzothiazole-4,7-diyl group substituted with a 4-methanesulfonylphenyl group; a benzothiazole-4,7-diyl group substituted with a thiophen-2-yl group; a benzothiazole-4,7-diyl group substituted with a thiophen-3-yl group; a benzothiazole-4,7-diyl group substituted with a 5-methylthiophen-2-yl group; a benzothiazole-4,7-diyl group substituted with a 5-chlorothiophen-2-yl group; a benzothiazole-4,7-diyl group substituted with a thieno[3,2-b]thiophen-2-yl group; a benzothiazole-4,7-diyl group substituted with a 2-benzothiazolyl group; a benzothiazole-4,7-diyl group substituted with a 4-biphenyl group; a benzothiazole-4,7-diyl group substituted with a 4-propylbiphenyl group; a benzothiazole-4,7-diyl group substituted with a 4-thiazolyl group; a benzothiazole-4,7-diyl group substituted with a 1-phenylethylene-2-yl group; a benzothiazole-4,7-diyl group substituted with a 4-pyridyl group; a benzothiazole-4,7-diyl group substituted with a 2-furyl group; a benzothiazole-4,7-diyl group substituted with a naphtho[1,2-b]furan-2-yl group; a 1H-isoindole-1,3(2H)-dione-4,7-diyl group substituted with a 5-methoxy-2-benzothiazolyl group; a 1H-isoindole-1,3(2H)-dione-4,7-diyl group substituted with a phenyl group; a 1H-isoindole-1,3(2H)-dione-4,7-diyl group substituted with a 4-nitrophenyl group; and a 1H-isoindole-1,3(2H)-dione-4,7-diyl group substituted with a 2-thiazolyl group. Herein, R^{f} and R^{f1} each independently represent the same meaning as Q¹ described later. R^{g} represents the same meaning as A^{y} described later, and R^{h} represents the same meaning as A^{x} described later.

In the above-described formula (Ia), Y^{1a} to Y^{8a} each independently represent a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—. Herein, R¹ represents a hydrogen atom or an alkyl group of 1 to 6 carbon atoms.

In the above-described formula (Ia), G^{1a} and G^{1a} each independently represent a divalent aliphatic group of 1 to 20 carbon atoms optionally having a substituent. The aliphatic group may contain one or more per aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein. However, cases where two or more —O— or —S— groups are inserted adjacently to each other are excluded. Herein, R² represents a hydrogen atom or an alkyl group of 1 to 6 carbon atoms.

In the above-described formula (Ia), Z^{1a} and Z^{2a} each independently represent an alkenyl group of 2 to 10 carbon atoms optionally substituted with a halogen atom.

In the above-described formula (Ia), A^{2a} and A^{3a} each independently represent a divalent alicyclic hydrocarbon group of 3 to 30 carbon atoms optionally having a substituent.

In the above-described formula (Ia), A^{4a} and A^{5a} each independently represent a divalent aromatic group of 6 to 30 carbon atoms optionally having a substituent.

In the above-described formula (Ia), k and l each independently represent 0 or 1.

Suitable specific examples of the polymerizable liquid crystal compound with reverse wavelength distribution may include a compound represented by the following formula (I). In the following description, the compound represented by the formula (I) is sometimes appropriately referred to as a “compound (I)”.

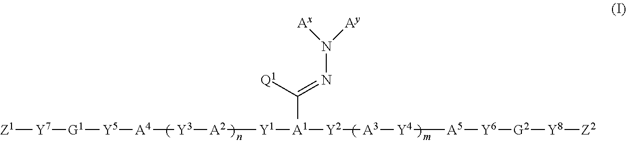

The compound (I) usually includes, as represented by the following formula, two mesogen skeletons: a main chain mesogen 1a consisting of a group-Y⁵-A⁴-(Y³-A²)ₙ-Y¹-A¹-Y²-(A³-Y⁴)ₘ-A⁵-Y⁶—, and a side chain mesogen 1b consisting of a group >A¹-C(Q¹)=N—N(A^{x})A^{y}. These main chain mesogen 1a and side chain mesogen 1b intersect each other. Although the main chain mesogen 1a and the side chain mesogen 1b may be integratedly regarded as one mesogen, these are described as two separate mesogens in the present invention.

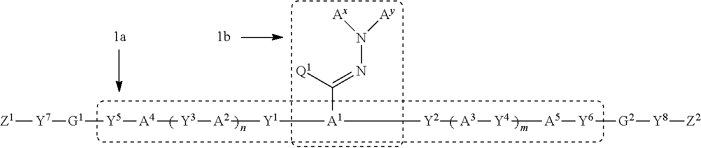

The refractive index of the main chain mesogen 1a in the long-axis direction is denoted a n1 and the refractive index of the side chain mesogen 1b in the long-axis direction is denoted as n2. In this case, the absolute value and wavelength distribution of the refractive index n1 usually depend on the molecular structure of the main chain mesogen 1a. The absolute value and wavelength distribution of the refractive index n2 usually depend on the molecular structure of the side chain mesogen 1b. In the liquid crystal phase, the polymerizable liquid crystal compound with reverse wavelength distribution is usually subjected to rotating movement around the long-axis direction of the main chain mesogen 1a as the rotation axis. The refractive indices n1 and n2 referred to herein represent the refractive indices as the bodies of rotation.

Due to the molecular structures of the main chain mesogen 1a and the side chain mesogen 1b, the absolute value of the refractive index n1 is larger than the absolute value of the refractive index n2. Further, the refractive indices n1 and n2 usually exhibit forward wavelength distribution. A refractive index with forward wavelength distribution herein represents a refractive index of which the absolute value is smaller as the measurement wavelength is longer. The refractive index n1 of the main chain mesogen 1a exhibits a small degree of forward wavelength distribution. Therefore, the refractive index n1 measured at a long wavelength is smaller than the refractive index n1 measured at a short wavelength, but the difference between the refractive indices is small. In contrast, the refractive index n2 of the side chain mesogen 1b exhibits a large degree of forward wavelength distribution. Therefore, the refractive index n2 measured at a long wavelength is smaller than the refractive index n2 measured at a short wavelength, and the difference between the refractive indices is large. Accordingly, the difference Δn between the refractive index n1 and the refractive index n2 is small with the short measurement wavelength, whereas the difference Δn of the refractive index n1 and the refractive index n2 is large with the long measurement wavelength. In this manner, the birefringence with reverse wavelength distribution may be expressed due to the main chain mesogen 1a and the side chain mesogen 1b.

In the above-described formula (I), Y¹ to Y⁸ each independently represent a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—.

Herein, R¹ represents a hydrogen atom or an alkyl group of 1 to 6 carbon atoms.

Examples of the alkyl group of 1 to 6 carbon atoms of R¹ may include a methyl group, an ethyl group, an n-propyl group, an isopropyl group, a n-butyl group, a sec-butyl group, a t-butyl group, a n-pentyl group, and a n-hexyl group.

R¹ is preferably a hydrogen atom or an alkyl group of 1 to 4 carbon atoms.

In the compound (I), Y¹ to Y⁸ each independently are preferably a chemical single bond, —O—, —O—C(═O)—, —C(═O)—O—, or —O—C(═O)—O—.

In the above-described formula (I), G¹ and G² each independently represent a divalent aliphatic group of 1 to 20 carbon atoms optionally having a substituent.

Examples of the divalent aliphatic group of 1 to 20 carbon atoms may include divalent aliphatic groups having a linear structure such as an alkylene group of 1 to 20 carbon atoms and an alkenylene group of 2 to 20 carbon atoms; and divalent aliphatic group such as a cycloalkanediyl group of 3 to 20 carbon atoms, a cycloalkenediyl group of 4 to 20 carbon atoms, and a divalent alicyclic fused ring group of 10 to 30 carbon atoms.

Examples of the substituent of the divalent aliphatic group of G¹ and G² may include a halogen atom such as a fluorine atom, a chlorine atom, a bromine atom, and an iodine atom; and an alkoxy group having 1 to 6 carbon atoms such as a methoxy group, an ethoxy group, a n-propoxy group, an isopropoxy group, a n-butoxy group, a sec-butoxy group, a t-butoxy group, a n-pentyloxy group, and a n-hexyloxy group. Among these, a fluorine atom, a methoxy group, and an ethoxy group are preferable.

The aliphatic group may contain one or more per aliphatic group of —O—, —S—, —O—C(═O)—, —C(═O)—O—, —O—C(═O)—O—, —NR²—C(═O)—, —C(═O)—NR²—, —NR²—, or —C(═O)— inserted therein. However, cases where two or more —O— or —S— groups are inserted adjacently to each other are excluded. Herein, R² represents a hydrogen atom or an alkyl group of 1 to 6 carbon atoms, and the hydrogen atom and a methyl group are preferable.

The group inserted in the aliphatic group is preferably —O—, —O—C(═O)—, —C(═O)—O—, or —C(═O).

Specific examples of the aliphatic group containing these groups inserted therein may include —CH₂—CH₂—O—CH₂—CH₂—, —CH₂—CH₂—S—CH₂—CH₂—, —CH₂—CH₂—O—C(═O)—CH₂—CH₂—, —CH₂—CH₂—C(═O)—O—CH₂—CH₂—, —CH₂—CH₂—C(═O)—O—CH₂—, —CH₂—O—C(═O)—O—CH₂—CH₂—, —CH₂—CH₂—NR²—C(═O)—CH₂—CH₂—, —CH₂—CH₂—C(═O)—NR²—CH₂—, —CH₂—NR²—CH₂—CH₂—, and —CH₂—C(═O)—CH₂—.

Among these, from the viewpoint of more favorably expressing a desired effect of the present invention, G¹ and G² each independently are preferably a divalent aliphatic group having a linear structure such as an alkylene group of 1 to 20 carbon atoms and an alkenylene group of 2 to 20 carbon atoms, more preferably an alkylene group of 1 to 12 carbon atoms such as a methylene group, an ethylene group, a trimethylene group, a propylene group, a tetramethylene group, a pentamethylene group, a hexamethylene group, an octamethylene group, or a decamethylene group [—(CH₂)₁₀—], and particularly preferably a tetramethylene group [—(CH₂)₄—], a hexamethylene group [—(CH₂)₆—], an octamethylene group [—(CH₂)₈—], or a decamethylene group [—(CH₂)₁₀—].

In the above-described formula (I), Z¹ and Z² each independently represent an alkenyl group of 2 to 10 carbon atoms optionally substituted with a halogen atom.

The number of carbon atoms of the alkenyl group is preferably 2 to 6. Examples of the halogen atom that is the substituent in the alkenyl group of Z¹ and Z² may include a fluorine atom, a chlorine atom, and a bromine atom, and a chlorine atom is preferable.

Specific examples of the alkenyl group of 2 to 10 carbon atoms of Z¹ and Z² may include CH₂═CH—, CH₂═C(CH₃)—, CH₂═CH—CH₂—, CH₃—CH═CH—, CH₂═CH—CH₂—CH₂—, CH₂═C(CH₃)—CH₂—CH₂—, (CH₃)₂C═CH—CH₂—, (CH₃)₂C═CH—CH₂—CH₂—, CH₂═C(Cl)—, CH₂═C(CH₃)—CH₂—, and CH₃—CH═CH—CH₂—.

Among these, from the viewpoint of more favorably expressing a desired effect of the present invention, Z¹ and Z² each independently are preferably CH₂═CH—, CH₂═C(CH₃)—, CH₂═C(Cl)—, CH₂═CH—CH₂—, CH₂═C(CH₃)—CH₂—, or CH₂═C(CH₃)—CH₂—CH₂—, more preferably CH₂═CH—, CH₂═C(CH₃)—, or CH₂═C(Cl)—, and particularly preferably CH₂═CH—.

In the above-described formula (I), A^{x} represents an organic group of 2 to 30 carbon atoms having at least one aromatic ring selected from the group consisting of an aromatic hydrocarbon ring and an aromatic heterocyclic ring. The “aromatic ring” means a cyclic structure having aromaticity in the broad sense based on Huckel rule, that is, a cyclic conjugated structure having (4n+2)π electrons, and a cyclic structure that exhibits aromaticity by involving a lone electron pair of heteroatom such as sulfur, oxygen, and nitrogen in a π electron system, typified by thiophene, furan, and benzothiazole.

The organic group of 2 to 30 carbon atoms having at least one aromatic ring selected from the group consisting of an aromatic hydrocarbon ring and an aromatic heterocyclic ring of A^{x} may be a group having a plurality of aromatic rings, or a group having both the aromatic hydrocarbon ring and the aromatic heterocyclic ring.

Examples of the aromatic hydrocarbon ring may include a benzene ring, a naphthalene ring, and an anthracene ring. Examples of the aromatic heterocyclic ring may include monocyclic aromatic heterocyclic rings such as a pyrrole ring, a furan ring, a thiophene ring, a pyridine ring, a pyridazine ring, a pyrimidine ring, a pyrazine ring, a pyrazole ring, an imidazole ring, an oxazole ring, and a thiazole ring; and fused aromatic heterocyclic rings such as a benzothiazole ring, a benzoxazole ring, a quinoline ring, a phthalazine ring, a benzimidazole ring, a benzopyrazole ring, a benzofuran ring, a benzothiophene ring, a thiazolopyridine ring, an oxazolopyridine ring, a thiazolopyrazine ring, an oxazolopyrazine ring, a thiazolopyridazine ring, an oxazolopyridazine ring, a thiazolopyrimidine ring, and an oxazolopyrimidine ring.

The aromatic ring contained in A^{x} may have a substituent. Examples of such a substituent may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; a halogenated alkyl group of 1 to 6 carbon atoms such as a trifluoromethyl group; a substituted amino group such as a dimethylamino group; an alkoxy group of 1 to 6 carbon atoms such as a methoxy group, an ethoxy group, and an isopropoxy group; a nitro group; a phenyl group; an aryl group such as a phenyl group and a naphthyl group; —C(═O)—R⁵; —C(═O)—OR⁵; and —SO₂R⁶. Herein, R⁵ represents an alkyl group of 1 to 20 carbon atoms, an alkenyl group of 2 to 20 carbon atoms, or a cycloalkyl group of 3 to 12 carbon atoms, and R⁶ represents the same groups as those for R⁴ described below, and is an alkyl group of 1 to 20 carbon atoms, an alkenyl group of 2 to 20 carbon atoms, a phenyl group, or a 4-methylphenyl group.

The aromatic ring contained in A^{x} may have a plurality of the same or different substituents, and adjacent two substituents may be bound to each other to together form a ring. The formed ring may be a monocycle, a fused polycycle, an unsaturated ring, or a saturated ring.

The “carbon atoms” of the organic group of 2 to 30 carbon atoms of A^{x} means the total number of carbon atoms of the entire organic group excluding the carbon atoms of the substituent(s) (the meaning of which is the same in A^{y} to be described later).

Examples of the organic group of 2 to 30 carbon atoms having at least one aromatic ring selected from the group consisting of an aromatic hydrocarbon ring and an aromatic heterocyclic ring of A^{x} may include an aromatic hydrocarbon ring group; an aromatic heterocyclic group; a group containing a combination of an aromatic hydrocarbon ring and a heterocyclic ring; an alkyl group of 3 to 30 carbon atoms having at least one aromatic ring selected from the group consisting of an aromatic hydrocarbon ring and an aromatic heterocyclic ring; an alkenyl group of 4 to 30 carbon atoms having at least one aromatic ring selected from the group consisting of an aromatic hydrocarbon ring and an aromatic heterocyclic ring; and an alkynyl group having 4 to 30 carbon atoms having at least one aromatic ring selected from the group consisting of an aromatic hydrocarbon ring and an aromatic heterocyclic ring.

Preferable specific examples of A^{x} are shown below, but A^{x} is not limited to the followings examples. In the following formulae, “—” represents a bond extending from an arbitrary position on the ring (the same applies to the following descriptions).

### (1) Aromatic Hydrocarbon Group

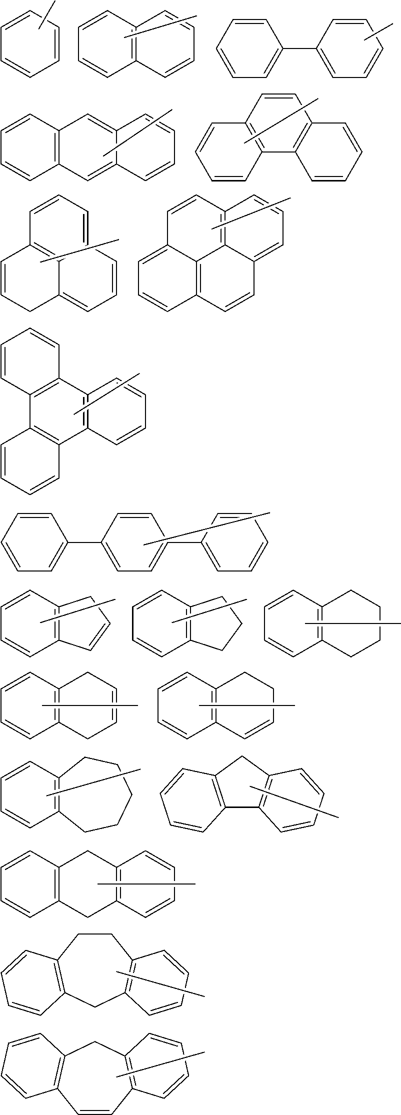

### (2) Aromatic Heterocyclic Ring Group

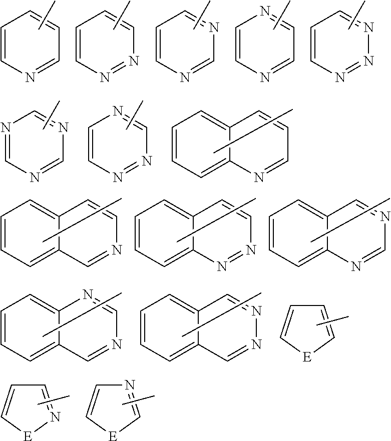

In the above-mentioned formulae, E represents NR^{6a}, an oxygen atom, or a sulfur atom. Herein, R^{6a} represents a hydrogen atom; or an alkyl group of 1 to 6 carbon atoms such as a methyl group, an ethyl group, and a propyl group.

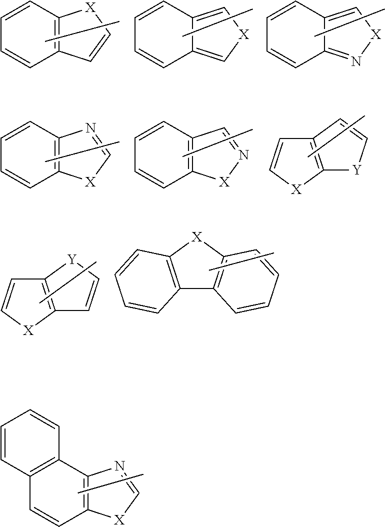

In the above-mentioned formulae, X and Y each independently represent NR⁷, an oxygen atom, a sulfur atom, —SO—, or —SO₂— (with a proviso that cases where oxygen atoms, sulfur atoms, —SO—, or —SO₂— are each adjacent to each other are excluded.). R⁷ represents the same substituents as those for R^{6a} described above, and is a hydrogen atom; or an alkyl group of 1 to 6 carbon atoms such as a methyl group, an ethyl group, and a propyl group.

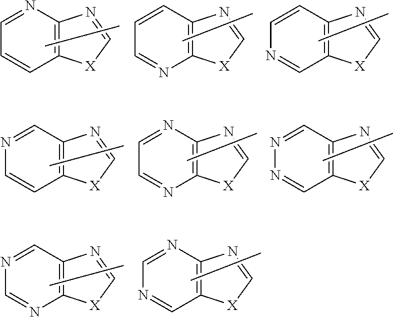

(In the above-mentioned formulae, X represents the same meanings as the previous descriptions.)

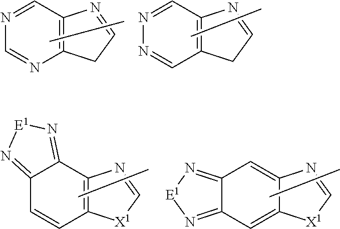

[In each of the formulae, X¹ represents —CH₂—, —NR^{c}—, an oxygen atom, a sulfur atom, —SO—, or —SO₂—, and E¹ represents —NR^{c}—, an oxygen atom, or a sulfur atom. Herein, R^{c} represents a hydrogen atom; or an alkyl group of 1 to 6 carbon atoms such as a methyl group, an ethyl group, and a propyl group. (However, in each of the formulae, oxygen atoms, sulfur atoms, —SO—, or —SO₂— are each not adjacent to each other.)]

### (3) Group Containing Combination of Aromatic Hydrocarbon Ring and Heterocyclic Ring

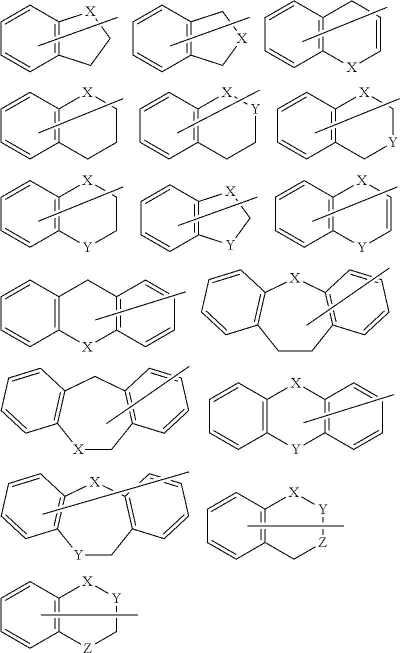

(In the above-mentioned formulae, X and Y each independently represent the same meanings as the previous descriptions. In the above-mentioned formulae, Z represents NR⁷, an oxygen atom, a sulfur atom, —SO—, or —SO₂— (with a proviso that cases where oxygen atoms, sulfur atoms, —SO—, or —SO₂— are each adjacent to each other are excluded.)
(4) Alkyl Group Containing at Least One Aromatic Ring Selected from the Group Consisting of Aromatic Hydrocarbon Ring and Aromatic Heterocyclic Ring

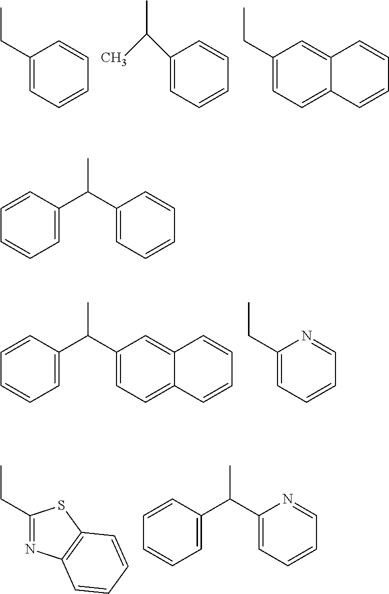

(5) Alkenyl Group Containing at Least One Aromatic Ring Selected from the Group Consisting of Aromatic Hydrocarbon Ring and Aromatic Heterocyclic Ring

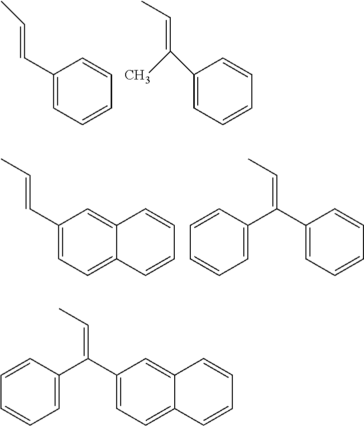

(6) Alkynyl Group Containing at Least One Aromatic Ring Selected from the Group Consisting of Aromatic Hydrocarbon Ring and Aromatic Heterocyclic Ring

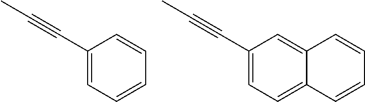

Among the above-mentioned A^{x}'s, an aromatic hydrocarbon ring group of 6 to 30 carbon atoms, an aromatic heterocyclic ring group of 4 to 30 carbon atoms, or a group of 4 to 30 carbon atoms containing a combination of an aromatic hydrocarbon ring and a heterocyclic ring is preferable. Any of the following groups is more preferable.

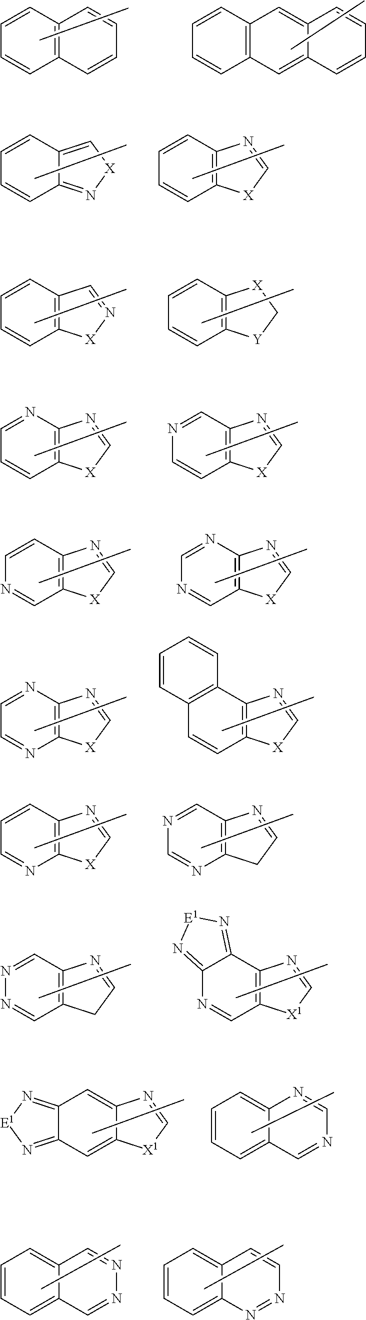

It is more preferable that A^{x} is any of the following groups.

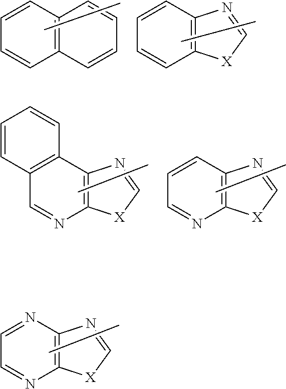

The ring contained in A^{x} may have a substituent. Examples of such a substituent may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; a halogenated alkyl group of 1 to 6 carbon atoms such as a trifluoromethyl group; a substituted amino group such as a dimethylamino group; an alkoxy group of 1 to 6 carbon atoms such as a methoxy group, an ethoxy group, and an isopropoxy group; a nitro group; an aryl group such as a phenyl group and a naphthyl group; —C(═O)—R⁸; —C(═O)—OR⁸; and —SO₂R⁶. Herein, R⁸ represents an alkyl group of 1 to 6 carbon atoms such as a methyl group and an ethyl group; or an aryl group of 6 to 14 carbon atoms such as a phenyl group. Among these, as the substituent, a halogen atom, a cyano group, an alkyl group of 1 to 6 carbon atoms, and an alkoxy group of 1 to 6 carbon atoms are preferable.

The ring contained in A^{x} may have a plurality of the same or different substituents, and adjacent two substituents may be bound to each other to together form a ring. The formed ring may be a monocycle, or a fused polycycle.

The “carbon atoms” of the organic group of 2 to 30 carbon atoms of A^{x} means the total number of carbon atoms of the entire organic group excluding the carbon atoms of the substituent (the meaning of which is the same in A^{y} to be described later).

In the above-described formula (I), A^{y} represents a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms containing at least one aromatic ring selected from the group consisting of an aromatic hydrocarbon ring and an aromatic heterocyclic ring. Herein, R³ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms. R⁴ represents an alkyl group of 1 to 20 carbon atoms, an alkenyl group of 2 to 20 carbon atoms, a phenyl group, or a 4-methylphenyl group. R⁹ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent.

Examples of the alkyl group of 1 to 20 carbon atoms in the alkyl group of 1 to 20 carbon atoms optionally having a substituent of A^{y} may include a methyl group, an ethyl group, a n-propyl group, an isopropyl group, a n-butyl group, an isobutyl group, a 1-methylpentyl group, a 1-ethylpentyl group, a sec-butyl group, a t-butyl group, a n-pentyl group, an isopentyl group, a neopentyl group, a n-hexyl group, an isohexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-icosyl group. The number of carbon atoms of the alkyl group of 1 to 20 carbon atoms optionally having a substituent is preferably 1 to 12, and more preferably 4 to 10.

Examples of the alkenyl group of 2 to 20 carbon atoms in the alkenyl group of 2 to 20 carbon atoms optionally having a substituent of A^{y} may include a vinyl group, a propenyl group, an isopropenyl group, a butenyl group, an isobutenyl group, a pentenyl group, a hexenyl group, a heptenyl group, an octenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, and an icosenyl group. The number of carbon atoms of the alkenyl group of 2 to 20 carbon atoms optionally having a substituent is preferably 2 to 12.

Examples of the cycloalkyl group of 3 to 12 carbon atoms in the cycloalkyl group of 3 to 12 carbon atoms optionally having a substituent of A^{y} may include a cyclopropyl group, a cyclobutyl group, a cyclopentyl group, a cyclohexyl group, and a cyclooctyl group.

Examples of the alkynyl group of 2 to 20 carbon atoms in the alkynyl group of 2 to 20 carbon atoms optionally having a substituent of A^{y} may include an ethynyl group a propynyl group, a 2-propynyl group (propargyl group), a butynyl group, a 2-butynyl group, a 3-butynyl group, a pentynyl group, a 2-pentynyl group, a hexynyl group, a 5-hexynyl group, a heptynyl group, an octynyl group, a 2-octynyl group, a nonanyl group, a decanyl group, and a 7-decanyl group.

Examples of the substituent in the alkyl group of 1 to 20 carbon atoms optionally having a substituent and the alkenyl group of 2 to 20 carbon atoms optionally having a substituent of A^{y} may include a halogen atom such as a fluorine atom and a chlorine atom; a cyano group; a substituted amino group such as a dimethylamino group; an alkoxy group of 1 to 20 carbon atoms such as a methoxy group, an ethoxy group, an isopropoxy group, and a butoxy group; an alkoxy group of 1 to 12 carbon atoms substituted with an alkoxy group of 1 to 12 carbon atoms such as a methoxymethoxy group and a methoxyethoxy group; a nitro group; an aryl group such as a phenyl group and a naphthyl group; a cycloalkyl group of 3 to 8 carbon atoms such as a cyclopropyl group, a cyclopentyl group, and a cyclohexyl group; a cycloalkyloxy group of 3 to 8 carbon atoms such as a cyclopentyloxy group and a cyclohexyloxy group; a cyclic ether group of 2 to 12 carbon atoms such as a tetrahydrofuranyl group, a tetrahydropyranyl group, a dioxolanyl group, and a dioxanyl group; an aryloxy group of 6 to 14 carbon atoms such as a phenoxy group and a naphthoxy group; a fluoroalkoxy group of 1 to 12 carbon atoms in which at least one of them is substituted with a fluorine atom such as a trifluoromethyl group, a pentafluoroethyl group, and —CH₂CF₃; a benzofuryl group; a benzopyranyl group; a benzodioxolyl group; a benzodioxanyl group; —C(═O)—R^{7a}; —C(═O)—OR^{7a}; —SO₂R^{8a}; —SR¹⁰; an alkoxy group of 1 to 12 carbon atoms substituted with —SR¹⁰; and a hydroxyl group. Herein, R^{7a} and R¹⁰ each independently represents an alkyl group of 1 to 20 carbon atoms, an alkenyl group of 2 to 20 carbon atoms, a cycloalkyl group of 3 to 12 carbon atoms, or an aromatic hydrocarbon ring group of 6 to 12 carbon atoms. R^{8a} represents the same groups as those for R⁴ described above, and is an alkyl group of 1 to 20 carbon atoms, an alkenyl group of 2 to 20 carbon atoms, a phenyl group, or a 4-methylphenyl group.

Examples of the substituent in the cycloalkyl group of 3 to 12 carbon atoms optionally having a substituent of A^{y} may include a halogen atom such as a fluorine atom and a chlorine atom; a cyano group; a substituted amino group such as a dimethylamino group; an alkyl group of 1 to 6 carbon atoms such as a methyl group, an ethyl group, and a propyl group; an alkoxy group of 1 to 6 carbon atoms such as a methoxy group, an ethoxy group, and an isopropoxy group; a nitro group; an aryl group such as a phenyl group and a naphthyl group; a cycloalkyl group of 3 to 8 carbon atoms such as a cyclopropyl group, a cyclopentyl group, and a cyclohexyl group; —C(═O)—R^{7a}; —C(═O)—OR^{7a}; —SO₂R^{8a}; and a hydroxyl group. Herein, R^{7a} and R^{8a} represent the same meaning as the previous descriptions.

Examples of the substituent in the alkynyl group of 2 to 20 carbon atoms optionally having a substituent of A^{y} may include the same substituents as those for the alkyl group of 1 to 20 carbon atoms optionally having a substituent and the alkenyl group of 2 to 20 carbon atoms optionally having a substituent.

In the group represented by —C(═O)—R⁸ of A^{y}, R³ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms. Specific examples of these may include the same examples as those exemplified for the alkyl group of 1 to 20 carbon atoms optionally having a substituent, the alkenyl group of 2 to 20 carbon atoms optionally having a substituent, and the cycloalkyl group of 3 to 12 carbon atoms optionally having a substituent of the above-described A^{y}; and the same examples as those exemplified for the aromatic hydrocarbon ring group of 5 to 12 carbon atoms among the aromatic hydrocarbon ring groups described for the above-described A^{x}.

In the group represented by —SO₂—R⁴ of A^{y}, R⁴ represents an alkyl group of 1 to 20 carbon atoms, an alkenyl group of 2 to 20 carbon atoms, a phenyl group, or a 4-methylphenyl group. Specific examples of the alkyl group of 1 to 20 carbon atoms and the alkenyl group of 2 to 20 carbon atoms of R⁴ may include the same groups as those exemplified for the alkyl group of 1 to 20 carbon atoms and the alkenyl group of 2 to 20 carbon atoms of the above-described A^{y}.

In the group represented by —C(═S)NH—R⁹ of A^{y}, R⁹ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent. Specific examples of these may include the same examples as those exemplified for the alkyl group of 1 to 20 carbon atoms optionally having a substituent, the alkenyl group of 2 to 20 carbon atoms optionally having a substituent, and the cycloalkyl group of 3 to 12 carbon atoms optionally having a substituent of the above-described A^{y}; and the same examples as those exemplified for the aromatic group, such as an aromatic hydrocarbon ring group and an aromatic heterocyclic ring group, of 5 to 20 carbon atoms among the aromatic groups described for the above-described A^{x}.

Examples of the organic group of 2 to 30 carbon atoms having at least one aromatic ring selected from the group consisting of an aromatic hydrocarbon ring and an aromatic heterocyclic ring of A^{y} may include the same groups as those described for the above-described A^{x}.

Among these, A^{y} is preferably a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, or an organic group of 2 to 30 carbon atoms having at least one aromatic ring selected from the group consisting of an aromatic hydrocarbon ring and an aromatic heterocyclic ring. Furthermore, A^{y} is more preferably a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, an aromatic hydrocarbon ring group of 6 to 12 carbon atoms optionally having a substituent, an aromatic heterocyclic ring group of 3 to 9 carbon atoms optionally having a substituent, a group of 3 to 9 carbon atoms optionally having a substituent and containing a combination of an aromatic hydrocarbon ring and a heterocyclic ring, or a group represented by —C(═O)—R³ or —SO₂—R⁴. Herein, R³ and R⁴ represent the same meaning as the previous descriptions.

The substituent contained in the alkyl group of 1 to 20 carbon atoms optionally having a substituent, the alkenyl group of 2 to 20 carbon atoms optionally having a substituent, and the alkynyl group of 2 to 20 carbon atoms optionally having a substituent of A^{y} is preferably a halogen atom, a cyano group, an alkoxy group of 1 to 20 carbon atoms, an alkoxy group of 1 to 12 carbon atoms substituted with an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a phenylsulfonyl group, a 4-methylphenylsulfonyl group, a benzoyl group, or —SR¹⁰. Herein, R¹⁰ represents the same meaning as the previous descriptions.

The substituent contained in the cycloalkyl group of 3 to 12 carbon atoms optionally having a substituent, the aromatic hydrocarbon ring group of 6 to 12 carbon atoms optionally having a substituent, the aromatic heterocyclic ring group of 3 to 9 carbon atoms optionally having a substituent, and the group of 3 to 9 carbon atoms optionally having a substituent and containing a combination of an aromatic hydrocarbon ring and a heterocyclic ring, of A^{y} is preferably a fluorine atom, an alkyl group of 1 to 6 carbon atoms, an alkoxy group of 1 to 6 carbon atom, or a cyano group.

A^{x} and A^{y} may form a ring together. Examples of such a ring may include an unsaturated heterocyclic ring of 4 to 30 carbon atoms optionally having a substituent and an unsaturated carbon ring of 6 to 30 carbon atoms optionally having a substituent.

The unsaturated heterocyclic ring of 4 to 30 carbon atoms and the unsaturated carbon ring of 6 to 30 carbon atoms are not particularly limited, and may or may not have aromaticity.

Examples of the ring formed by A^{x} and A^{y} together may include the following rings. Note that the following rings are shown as a part represented by

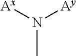

in the formula (I).

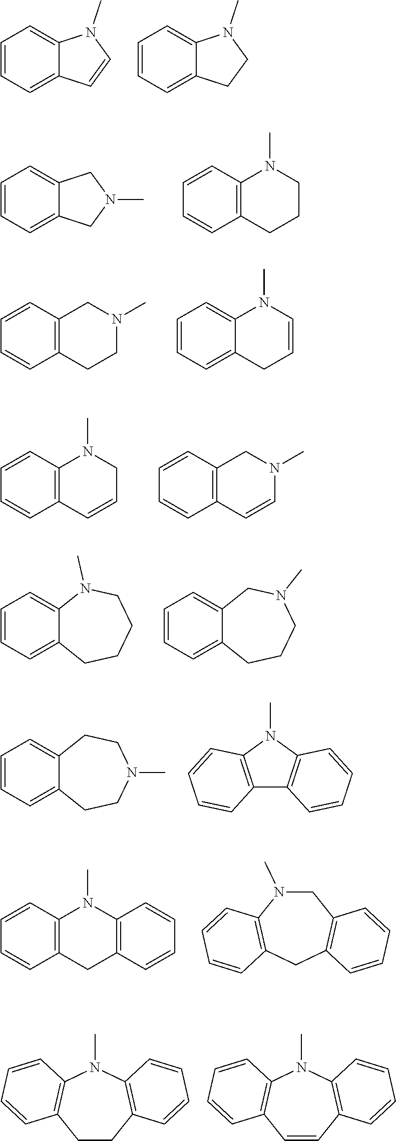

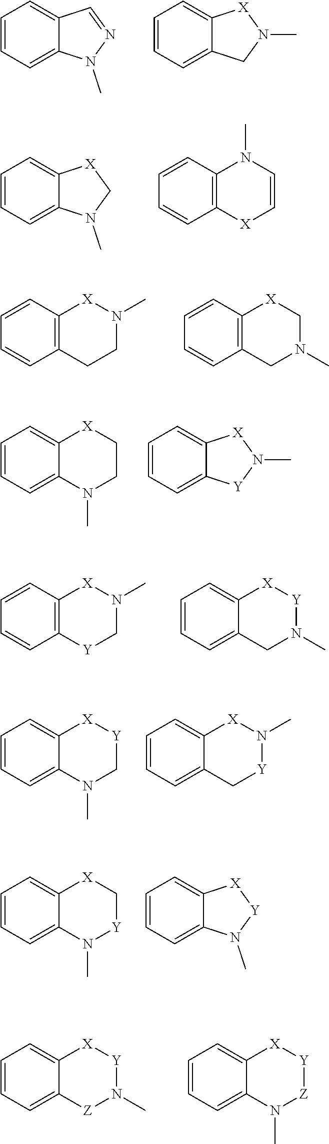

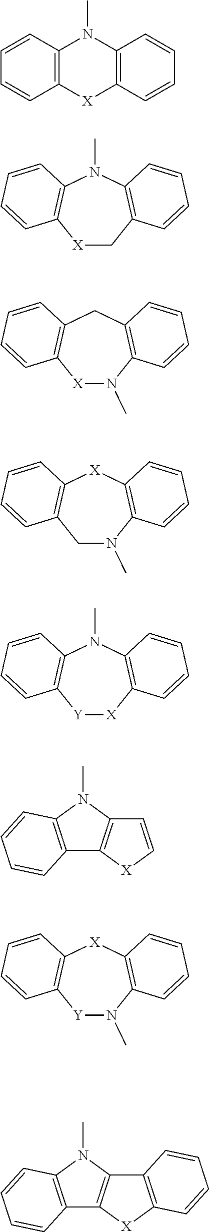

(In the formulae, X, Y, and Z represent the same meaning as the previous descriptions.)

These rings may have a substituent. Examples of such a substituent may include the same substituents as those described as the substituent of the aromatic ring contained in A^{x}.

The total number of π electrons contained in A^{x} and A^{y} is preferably 4 or more and 24 or less, more preferably 6 or more and 20 or less, and further more preferably 6 or more and 18 or less, from the viewpoint of more favorably expressing a desired effect of the present invention.

Examples of the preferable combination of A^{x} and A^{y} may include the following combinations (α) and (β).

(α) A combination in which A^{x} is an aromatic hydrocarbon ring group of 4 to 30 carbon atoms, an aromatic heterocyclic group of 4 to 30 carbon atoms, or a group of 4 to 30 carbon atoms containing a combination of an aromatic hydrocarbon ring and a heterocyclic ring; and A^{y} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic ring group of 3 to 9 carbon atoms optionally having a substituent (a halogen atom, an alkyl group of 1 to 6 carbon atoms, an alkoxy group of 1 to 6 carbon atoms, or a cyano group), a group of 3 to 9 carbon atoms optionally having a substituent (a halogen atom, an alkyl group of 1 to 6 carbon atoms, an alkoxy group of 1 to 6 carbon atoms, or a cyano group) and containing a combination of an aromatic hydrocarbon ring and a heterocyclic ring, an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, in which the substituent is any of a halogen atom, a cyano group, an alkoxy group of 1 to 20 carbon atoms, an alkoxy group of 1 to 12 carbon atoms substituted with an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰.

(β) A combination in which A^{x} and A^{y} together form an unsaturated heterocyclic ring or an unsaturated carbon ring.

Herein, R¹⁰ represents the same meaning as the previous description.

Examples of the more preferable combination of A^{x} and A^{y} may include the following combinations (γ).

(γ) A combination in which A^{x} is a group having any of the following structures; and A^{y} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic ring group of 3 to 9 carbon atoms optionally having a substituent (a halogen atom, an alkyl group of 1 to 6 carbon atoms, an alkoxy group of 1 to 6 carbon atoms, or a cyano group), a group of 3 to 9 carbon atoms optionally having a substituent (a halogen atom, an alkyl group of 1 to 6 carbon atoms, an alkoxy group of 1 to 6 carbon atoms, or a cyano group) and containing a combination of an aromatic hydrocarbon ring and a heterocyclic ring, an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, in which the substituent is any of a halogen atom, a cyano group, an alkoxy group of 1 to 20 carbon atoms, an alkoxy group of 1 to 12 carbon atoms substituted with an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰.

Herein, R₁₀ represents the same meaning as the previous description.

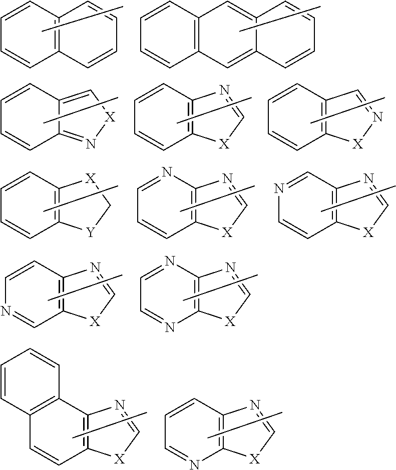

(In the formulae, X and Y represent the same meanings as the previous descriptions.)

Examples of the particularly preferable combination of A^{x} and A^{y} may include the following combination (δ).

(δ) A combination in which A^{x} is a group having any of the following structures; and A^{y} is a hydrogen atom, a cycloalkyl group of 3 to 8 carbon atoms, an aromatic hydrocarbon ring group of 6 to 12 carbon atoms optionally having a substituent (a halogen atom, a cyano group, an alkyl group of 1 to 6 carbon atoms, an alkoxy group of 1 to 6 carbon atoms, or a cycloalkyl group of 3 to 8 carbon atoms), an aromatic heterocyclic ring group of 3 to 9 carbon atoms optionally having a substituent (a halogen atom, an alkyl group of 1 to 6 carbon atoms, an alkoxy group of 1 to 6 carbon atoms, or a cyano group), a group of 3 to 9 carbon atoms optionally having a substituent (a halogen atom, an alkyl group of 1 to 6 carbon atoms, an alkoxy group of 1 to 6 carbon atoms, or a cyano group) and containing a combination of an aromatic hydrocarbon ring and a heterocyclic ring, an alkyl group of 1 to 20 carbon atoms optionally having a substituent, an alkenyl group of 1 to 20 carbon atoms optionally having a substituent, or an alkynyl group of 2 to 20 carbon atoms optionally having a substituent, in which the substituent is any of a halogen atom, a cyano group, an alkoxy group of 1 to 20 carbon atoms, an alkoxy group of 1 to 12 carbon atoms substituted with an alkoxy group of 1 to 12 carbon atoms, a phenyl group, a cyclohexyl group, a cyclic ether group of 2 to 12 carbon atoms, an aryloxy group of 6 to 14 carbon atoms, a hydroxyl group, a benzodioxanyl group, a benzenesulfonyl group, a benzoyl group, and —SR¹⁰.

In the following formulae, X represents the same meaning as the previous description. Herein, R¹⁰ represents the same meaning as the previous description.

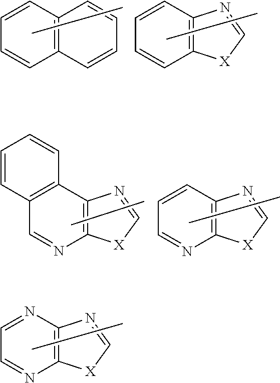

In the above-described formulae (I), A¹ represents a trivalent aromatic group optionally having a substituent. The trivalent aromatic group may be a trivalent carbocyclic aromatic group, or may be a trivalent heterocyclic aromatic group. From the viewpoint of more favorably expressing a desired effect of the present invention, a trivalent carbocyclic aromatic group is preferable, a trivalent benzene ring group or a trivalent naphthalene ring group is more preferable, and a trivalent benzene ring group or a trivalent naphthalene ring group represented by the following formulae is further preferable. In the following formulae, substituents Y¹ and Y² are described for the sake of more clearly indicating the binding state (Y¹ and Y² represent the same meanings as the previous descriptions, and the same applies to the following descriptions).

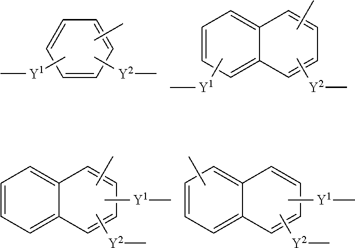

Among these, A¹ is more preferably a group represented by any of the following formulae (A11) to (A25), further preferably a group represented by any of the formulae (A11), (A13), (A15), (A19), and (A23), and particularly preferably a group represented by any of the formulae (A11) and (A23).

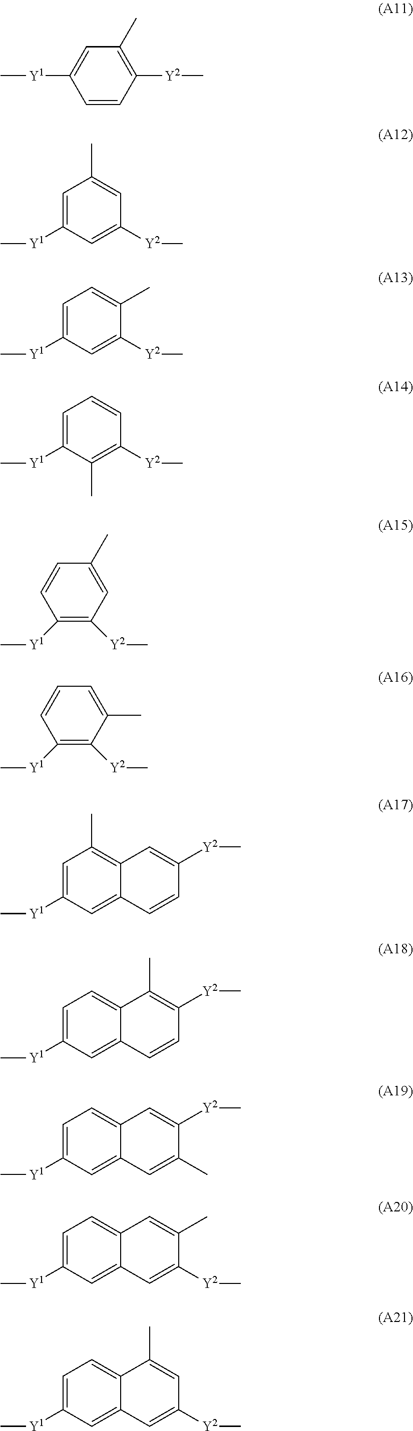

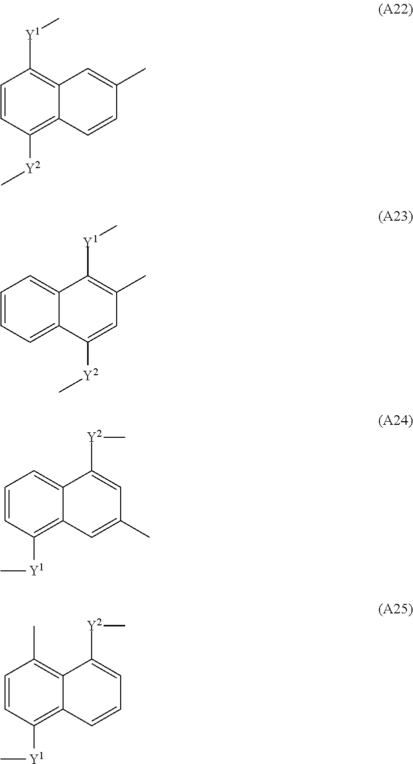

Examples of the substituent that the trivalent aromatic group of A¹ may have may include the same substituents as those described as the substituent of the aromatic ring of the above-described A^{x}. It is preferable that A¹ does not contain a substituent.

In the above-described formula (I), A² and A³ each independently represent a divalent alicyclic hydrocarbon group of 3 to 30 carbon atoms optionally having a substituent. Examples of the divalent alicyclic hydrocarbon group of 3 to 30 carbon atoms may include a cycloalkanediyl group of 3 to 30 carbon atoms and a divalent alicyclic fused ring group of 10 to 30 carbon atoms.

Examples of the cycloalkanediyl group of 3 to 30 carbon atoms may include a cyclopropanediyl group; a cyclobutanediyl group such as a cyclobutane-1,2-diyl group and a cyclobutane-1,3-diyl group; a cyclopentanediyl group such as a cyclopentane-1,2-diyl group and a cyclopentane-1,3-diyl group; a cyclohexanediyl group such as a cyclohexane-1,2-diyl group, a cyclohexane-1,3-diyl group, and a cyclohexane-1,4-diyl group; a cycloheptanediyl group such as a cycloheptane-1,2-diyl group, a cycloheptane-1,3-diyl group, and a cycloheptane-1,4-diyl group; a cyclooctanediyl group such as a cyclooctane-1,2-diyl group, a cyclooctane-1,3-diyl group, a cyclooctane-1,4-diyl group, and a cyclooctane-1,5-diyl group; a cyclodecanediyl group such as a cyclodecane-1,2-diyl group, a cyclodecane-1,3-diyl group, a cyclodecane-1,4-diyl group, and a cyclodecane-1,5-diyl group; a cyclododecanediyl group such as a cyclododecane-1,2-diyl group, a cyclododecane-1,3-diyl group, a cyclododecane-1,4-diyl group, and a cyclododecane-1,5-diyl group; a cyclotetradecanediyl group such as a cyclotetradecane-1,2-diyl group, a cyclotetradecane-1,3-diyl group, a cyclotetradecane-1,4-diyl group, a cyclotetradecane-1,5-diyl group, and a cyclotetradecane-1,7-diyl group; and a cycloeicosanediyl group such as a cycloeicosane-1,2-diyl group and a cycloeicosane-1,10-diyl group.

Examples of the divalent alicyclic fused ring group of 10 to 30 carbon atoms may include: a decalindiyl group such as a decalin-2,5-diyl group and a decalin-2,7-diyl group; an adamantanediyl group such as an adamantane-1,2-diyl group and an adamantane-1,3-diyl group; and a bicyclo[2.2.1]heptanediyl group such as a bicyclo[2.2.1]heptane-2,3-diyl group, a bicyclo[2.2.1]heptane-2,5-diyl group, and a bicyclo[2.2.1]heptane-2,6-diyl group.

These divalent alicyclic hydrocarbon groups may have a substituent at an optional position. Examples of the substituent may include the same substituents as those described as the substituent of the aromatic ring of the above-described A^{x}.

Among these, A² and A³ are preferably a divalent alicyclic hydrocarbon group of 3 to 12 carbon atoms, more preferably a cycloalkanediyl group of 3 to 12 carbon atoms, further preferably a group represented by any of the following formulae (A31) to (A34), and particularly preferably a group represented by the following formula (A32).

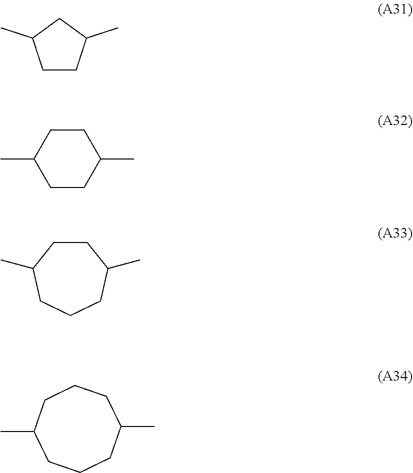

The divalent alicyclic hydrocarbon group of 3 to 30 carbon atoms may have a cis stereoisomer and a trans stereoisomer based on a difference in the steric configuration of a carbon atom bound to Y¹ and Y³ (or Y² and Y⁴). For example, a cyclohexane-1,4-diyl group may have, as indicated below, a cis isomer (A32a) and a trans isomer (A32b).

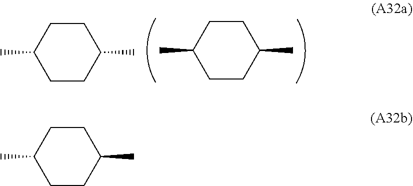

The aforementioned divalent alicyclic hydrocarbon group of 3 to 30 carbon atoms may be a cis isomer, a trans isomer, or a cis and trans isomeric mixture. Among these, a trans isomer or a cis isomer is preferable, and a trans isomer is more preferable, from the viewpoint of favorable orientation quality.

In the above-described formula (I), A⁴ and A⁵ each independently represent a divalent aromatic group of 6 to 30 carbon atoms optionally having a substituent. The aromatic group of A⁴ and A⁵ may be monocyclic or polycyclic. Specific preferable examples of A⁴ and A⁵ may be as follows.

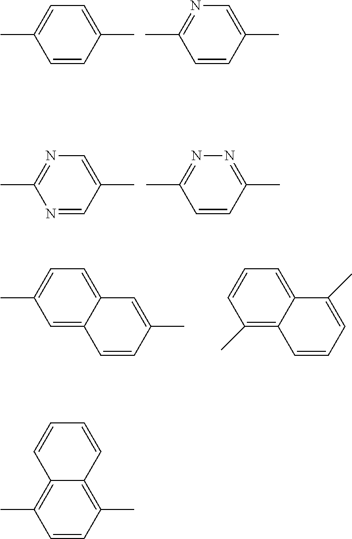

The divalent aromatic group of A⁴ and A⁵ may optionally have a substituent at an optional position. Examples of the substituent may include a halogen atom, a cyano group, a hydroxyl group, an alkyl group of 1 to 6 carbon atoms, an alkoxy group of 1 to 6 carbon atoms, a nitro group, and a —C(═O)—OR^{8b} group. Herein, R^{8b} is an alkyl group of 1 to 6 carbon atoms. Among these, as the substituent, a halogen atom, an alkyl group of 1 to 6 carbon atoms, and an alkoxy group are preferable. The halogen atom is more preferably a fluorine atom. The alkyl group of 1 to 6 carbon atoms is more preferably a methyl group, an ethyl group, or a propyl group. The alkoxy group is more preferably a methoxy group or an ethoxy group.

Among these, from the viewpoint of more favorably expressing a desired effect of the present invention, A⁴ and A⁵ each independently are more preferably a group represented by the following formula (A41), (A42) or (A43) optionally having a substituent, and particularly preferably a group represented by the formula (A41) optionally having a substituent.

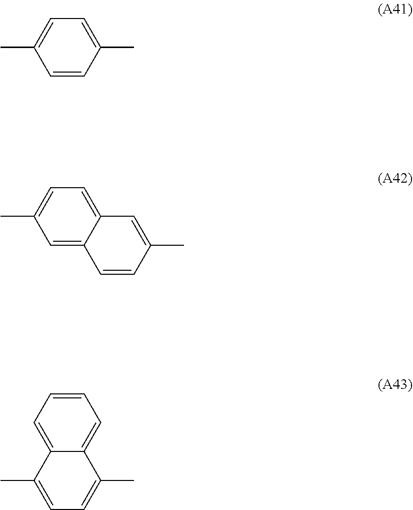

In the above-described formula (I), Q¹ represents a hydrogen atom or an alkyl group of 1 to 6 carbon atoms optionally having a substituent. Examples of the alkyl group of 1 to 6 carbon atoms optionally having a substituent may include an alkyl group of 1 to 6 carbon atoms among the alkyl groups of 1 to 20 carbon atoms optionally having a substituent which have been described for the above-described A^{y}. Among these, Q¹ is preferably a hydrogen atom or an alkyl group of 1 to 6 carbon atoms, and more preferably a hydrogen atom or a methyl group.

In the above-described formula (I), m and n each independently represent 0 or 1. In particular, m is preferably 1, and n is preferably 1.

The compound (I) may be produced by a reaction as shown below.

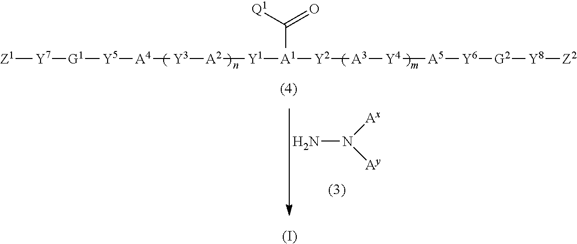

(In the formula, Y¹ to Y⁸, G¹, G², Z¹, Z², A^{x}, A^{y}, A¹ to A⁵, Q¹, m, and n represent the same meanings as the previous descriptions.)

As shown in the aforementioned reaction formula, a hydrazine compound represented by the formula (3) and a carbonyl compound represented by the formula (4) may be reacted to produce a compound (I). Hereinafter, the hydrazine compound represented by the formula (3) may be appropriately referred to as a “hydrazine compound (3)”. The carbonyl compound represented by the formula (4) may be appropriately referred to as a “carbonyl compound (4)”.

In the aforementioned reaction, the molar ratio of “hydrazine compound (3):carbonyl compound (4)” is preferably 1:2 to 2:1, and more preferably 1:1.5 to 1.5:1. When the reaction is performed with such a molar ratio, the target compound (I) can be produced in a highly selective manner with a high yield.

In this case, the reaction system may contain an acid catalyst that is, for example, an organic acid such as (±)-10-camphorsulfonic acid and paratoluenesulfonic acid; and an inorganic acid such as hydrochloric acid and sulfuric acid. By using the acid catalyst, the reaction time may be shortened and the yield may be improved. The amount of the acid catalyst is usually 0.001 mol to 1 mol relative to 1 mol of the carbonyl compound (4). The acid catalyst as it is may be added to the reaction system, or may be added as a solution in which it is dissolved in an appropriate solution.

As the solvent used for this reaction, a solvent which is inactive to the reaction may be used. Examples of the solvent may include: an alcohol-based solvent such as methyl alcohol, ethyl alcohol, n-propyl alcohol, isopropyl alcohol, n-butyl alcohol, isobutyl alcohol, sec-butyl alcohol, and t-butyl alcohol; an ether-based solvent such as diethyl ether, tetrahydrofuran, 1,2-dimethoxyethane, 1,4-dioxane, and cyclopentyl methyl ether; an ester-based solvent such as ethyl acetate, propyl acetate, and methyl propionate; an aromatic hydrocarbon-based solvent such as benzene, toluene, and xylene; an aliphatic hydrocarbon-based solvent such as n-pentane, n-hexane, and n-heptane; an amide-based solvent such as N,N-dimethylformamide, N-methylpyrrolidone, and hexamethylphosphoric triamide; a sulfur-containing solvent such as dimethyl sulfoxide and sulfolane; and a mixed solvent containing two or more thereof. Among these, an alcohol-based solvent, an ether-based solvent, and a mixed solvent of an alcohol-based solvent and an ether-based solvent are preferable.

The using amount of the solvent is not particularly limited, and may be set in consideration of the type of the compound used, the reaction scale, and the like. The specific using amount of the solvent is usually 1 g to 100 g relative to 1 g of the hydrazine compound (3).

Usually the reaction may smoothly proceed in the temperature range of not lower than −10° C. and not higher than the boiling point of the used solvent. The reaction time for each reaction is usually several minutes to several hours depending on the reaction scale.

The hydrazine compound (3) may be produced in the following manner.

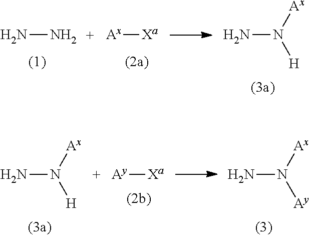

(In the formula, A^{x} and A^{y} represent the same meanings as the previous descriptions, and X^{a} represents a leaving group such as a halogen atom, a methanesulfonyloxy group, and a p-toluenesulfonyloxy group.)

As shown in the aforementioned reaction formula, a compound represented by the formula (2a) and a hydrazine (1) may be reacted in an appropriate solvent to obtain a corresponding hydrazine compound (3a). The molar ratio of “compound (2a):hydrazine (1)” in this reaction is preferably 1:1 to 1:20, and more preferably 1:2 to 1:10. Furthermore, the hydrazine compound (3a) and a compound represented by the formula (2b) may be reacted to obtain a hydrazine compound (3).

The hydrazine (1) to be used is usually a monohydrate. As the hydrazine (1), a commercially available product as it is may be used.

As the solvent used for this reaction, a solvent which is inactive to the reaction may be used. Examples of the solvent may include: an alcohol-based solvent such as methyl alcohol, ethyl alcohol, n-propyl alcohol, isopropyl alcohol, n-butyl alcohol, isobutyl alcohol, sec-butyl alcohol, and t-butyl alcohol; an ether-based solvent such as diethyl ether, tetrahydrofuran, 1,2-dimethoxyethane, 1,4-dioxane, and cyclopentyl methyl ether; an aromatic hydrocarbon-based solvent such as benzene, toluene, and xylene; an aliphatic hydrocarbon-based solvent such as n-pentane, n-hexane, and n-heptane; an amide-based solvent such as N,N-dimethylformamide, N-methylpyrrolidone, and hexamethylphosphoric triamide; a sulfur-containing solvent such as dimethyl sulfoxide and sulfolane; and a mixed solvent containing two or more thereof. Among these, an alcohol-based solvent, an ether-based solvent, and a mixed solvent of an alcohol-based solvent and an ether-based solvent are preferable.

The using amount of the solvent is not particularly limited, and may be set in consideration of the type of the compound used, the reaction scale, and the like. The specific using amount of the solvent is usually 1 g to 100 g relative to 1 g of hydrazine.

Usually the reaction may smoothly proceed in the temperature range of not lower than −10° C. and not higher than the boiling point of a used solvent. The reaction time for each reaction is usually several minutes to several hours depending on the reaction scale.

The hydrazine compound (3) may also be produced by reducing a diazonium salt (5) using publicly known method in the following manner.

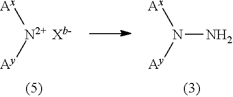

In the formula (5), A^{x} and A^{y} represent the same meanings as the previous descriptions. X^{b-} represents an anion which is a counter ion to diazonium. Examples of X^{b-} may include: inorganic anions such as a hexafluorophosphate ion, a hydrofluoroborate ion, a chloride ion, and a sulfate ion; and organic anions such as a polyfluoroalkylcarboxylate ion, a polyfluoroalkylsulfonate ion, a tetraphenylborate ion, an aromatic carboxylate ion, and an aromatic sulfonate ion.

Examples of a reductant used in the reaction may include a metal salt reductant. The metal salt reductant is generally a compound containing low valent metal or a compound having a metal ion and a hydride source (see “Yuki Gosei Jikkenhou Handbook (Organic synthesis experimental method handbook)”, 1990, edited by The Society of Synthetic Organic Chemistry, Japan, published by Maruzen Co., Ltd., p. 810).

Examples of the metal salt reductant may include NaAlH₄, NaAlHₚ(Or)_{q} (wherein p and q each independently are an integer of 1 to 3, p+q is 4, and r represents an alkyl group of 1 to 6 carbon atoms), LiAlH₄, iBu₂AlH, LiBH₄, NaBH₄, SnCl₂, CrCl₂, and TiCl₃. Herein, “iBu” represents an isobutyl group.

In the reduction reaction, any of publicly known reaction conditions may be adopted. For example, the reaction may be performed under conditions described in documents including Japanese Patent Application Laid-Open No. 2005-336103 A, Shin Jikken Kagaku Koza (New course of experimental chemistry), 1978, published by Maruzen Co., Ltd., vol. 14, and Jikken Kagaku Koza (Course of experimental chemistry), 1992, published by Maruzen Co., Ltd., vol. 20.

The diazonium salt (5) may be produced from a compound such as aniline by an ordinary method.

The carbonyl compound (4) may be produced, for example, by appropriately bonding and modifying a plurality of publicly known compounds having a desired structure by any combination of reactions of forming an ether bond (—O—), an ester bond (—C(═O)—O— and —O—C(═O)—), a carbonate bond (—O—C(═O)—O—), and an amide bond (—C(═O)NH— and —NH—C(═O)—).

The ether bond may be formed in the follow manner.

(i) A compound represented by a formula: D1-hal (hal represents a halogen atom, and the same applies to the following descriptions) and a compound represented by a formula: D2-OMet (Met represents an alkaline metal (mainly sodium), and the same applies to the following descriptions) are mixed and condensed (Williamson synthesis). In the formulae, D1 and D2 are an optional organic group (the same applies to the following descriptions).

(ii) A compound represented by a formula: D1-hal and a compound represented by a formula: D2-OH are mixed and condensed in the presence of a base such as sodium hydroxide and potassium hydroxide.

(iii) A compound represented by a formula: D1-J (J represents an epoxy group) and a compound represented by a formula: D2-OH are mixed and condensed in the presence of a base such as sodium hydroxide and potassium hydroxide.

(iv) A compound represented by a formula: D1-OFN (OFN represents a group having an unsaturated bond) and a compound represented by a formula: D2-OMet are mixed in the presence of a base such as sodium hydroxide and potassium hydroxide for addition reaction.

(v) A compound represented by a formula: D1-hal and a compound represented by a formula: D2-OMet are mixed and condensed in the presence of copper or cuprous chloride (Ullmann condensation).

The ester bond and the amide bond may be formed in the following manner.

(vi) A compound represented by a formula: D1-COOH and a compound represented by a formula: D2-OH or D2-NH₂ are subjected to dehydration condensation in the presence of a dehydration-condensation agent (N,N-dicyclohexylcarbodiimide and the like).

(vii) A halogenating agent is allowed to act on a compound represented by a formula: D1-COOH to obtain a compound represented by a formula: D1-CO-hal, and the resultant product is reacted with a compound represented by a formula: D2-OH or D2-NH₂ in the presence of a base.

(viii) An acid anhydride is allowed to act on a compound represented by a formula: D1-COOH to obtain a mixed acid anhydride, and the resultant product is reacted with a compound represented by a formula: D2-OH or D2-NH₂.

(ix) A compound represented by a formula: D1-COOH and a compound represented by a formula: D2-OH or D2-NH₂ are subjected to dehydration condensation in the presence of a base catalyst or an acid catalyst.

More specifically, the carbonyl compound (4) may be produced by a method shown in the following reaction formula.

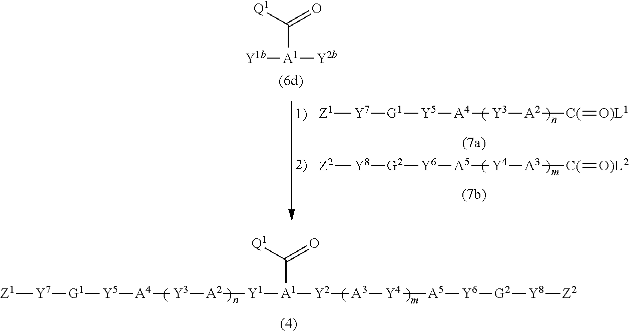

(In the formula, Y¹ to Y⁸, G¹, G², Z¹, Z², A¹ to A⁵, Q¹, m, and n represent the same meanings as the previous descriptions. L¹ and L² each independently represent a leaving group such as a hydroxyl group, a halogen atom, a methanesulfonyloxy group, and a p-toluenesulfonyloxy group. -Y^{1b} represents a group which can react with -L¹ to become -Y¹-, and -Y^{2b} represents a group which can react with -L² to become -Y²-.)

As shown in the aforementioned reaction formula, through formation reaction of an ether bond (—O—), an ester bond (—C(═O)—O—, —O—C(═O)—), or a carbonate bond (—O—C(═O)—O—), a compound represented by the formula (6d) may be reacted with a compound represented by the formula (7a), and subsequently with a compound represented by the formula (7b), to produce the carbonyl compound (4).

As a specific example, a method for producing a compound (4′) in which Y¹ is a group represented by a formula: Y¹¹—C(═O)—O—, and a group represented by a formula: Z²-Y⁸-G²-Y⁶-A⁵-(Y⁴-A³)ₘ-Y²- is the same as a group represented by a formula: Z¹-Y⁷-G¹-Y⁵-A⁴-(Y³-A²)ₙ-Y¹- will be shown below.

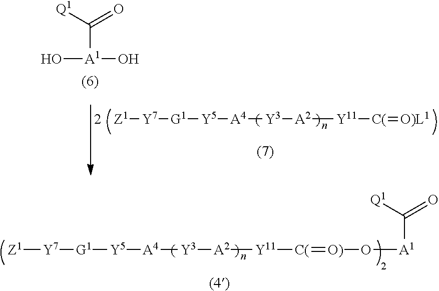

(In the formula, Y³, Y⁵, Y⁷, G¹, Z¹, A¹, A², A⁴, Q¹, n, and L¹ represent the same meanings as the previous descriptions. Y¹¹ represents a group which allows Y¹¹—C(═O)—O— to become Y¹. Y¹ represents the same meaning as the previous description.)

As shown in the aforementioned reaction formula, a dihydroxy compound represented by the formula (6) (compound (6)) and a compound represented by the formula (7) (compound (7)) may be reacted to produce the compound (4′). The molar ratio of “compound (6):compound (7)” in this reaction is preferably 1:2 to 1:4, and more preferably 1:2 to 1:3. When the reaction is performed with such a molar ratio, the target compound (4′) can be produced in a highly selective manner with a high yield.

When the compound (7) is a compound including a hydroxyl group as L¹ (carboxylic acid), it can be reacted in the presence of a dehydration-condensation agent such as 1-ethyl-3-(3-dimethylaminopropyl)carbodiimide hydrochloride and dicyclohexylcarbodiimide to obtain a target product. The using amount of the dehydration-condensation agent is usually 1 mol to 3 mol relative to 1 mol of the compound (7).

When the compound (7) is a compound including a hydroxyl group as L¹ (carboxylic acid), it may also be reacted in the presence of a sulfonyl halide such as methanesulfonyl chloride and p-toluenesulfonyl chloride and a base such as triethylamine, diisopropylethylamine, pyridine, and 4-(dimethylamino)pyridine to obtain a target product. The using amount of the sulfonyl halide is usually 1 mol to 3 mol relative to 1 mol of the compound (7). The using amount of the base is usually 1 mol to 3 mol relative to 1 mol of the compound (7). In this case, a compound containing a sulfonyloxy group as L¹ in the above-described formula (7) (mixed acid anhydride) may be isolated to perform the following reaction.

Furthermore, when the compound (7) is a compound including a halogen atom as L¹ (acid halide), it may be reacted in the presence of a base to obtain a target product. Examples of the base may include: an organic base such as triethylamine and pyridine; and an inorganic base such as sodium hydroxide, sodium carbonate, and sodium bicarbonate. The using amount of the base is usually 1 mol to 3 mol relative to 1 mol of the compound (7).

Examples of the solvent used in the aforementioned reaction may include: a chlorine-based solvent such as chloroform and methylene chloride; an amide-based solvent such as N-methylpyrrolidone, N,N-dimethylformamide, N,N-dimethylacetamide, and hexamethylphosphoric triamide; an ether solvent such as 1,4-dioxane, cyclopentyl methyl ether, tetrahydrofuran, tetrahydropyran, and 1,3-dioxolane; a sulfur-containing solvent such as dimethylsulfoxide and sulfolane; an aromatic hydrocarbon-based solvent such as benzene, toluene, and xylene; an aliphatic hydrocarbon-based solvent such as n-pentane, n-hexane, and n-octane; an alicyclic hydrocarbon-based solvent such as cyclopentane and cyclohexane; and a mixed solvent containing two or more thereof.

The using amount of the solvent is not particularly limited, and may be set in consideration of the type of a compound used, the reaction scale, and the like. The specific using amount of the solvent is usually 1 g to 50 g relative to 1 g of the hydroxy compound (6).

Many of the compounds (6) are publicly known substances, and may be produced by a publicly known method. For example, they may be produced by a method shown in the following reaction formula (see, for example, International Publication No. 2009/042544 A, and The Journal of Organic Chemistry, 2011, 76, 8082-8087). As the compound (6), a commercially available product may be used after, if desired, purification.

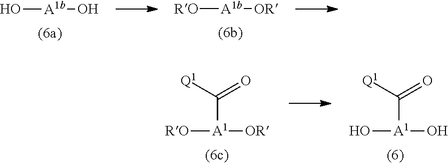

(In the formula, A¹ and Q¹ represent the same meanings as the previous descriptions, A^{1b} represents a divalent aromatic group which is capable of being formylated or acylated to become A¹, and R′ represents a protecting group of a hydroxyl group, for example, an alkyl group of 1 to 6 carbon atoms such as a methyl group and an ethyl group, and an alkoxy alkyl group of 2 to 6 carbon atoms such as a methoxymethyl group.)

As shown in the aforementioned reaction formula, a hydroxyl group of a dihydroxy compound represented by the formula (6a) (1,4-dihydroxybenzene, 1,4-dihydroxynaphthalene, and the like) is alkylated to obtain a compound represented by the formula (6b). After that, the ortho position of an OR′ group is formylated or acylated by a publicly known method to obtain a compound represented by the formula (6c). Then, the resultant product may be deprotected (dealkylated) to produce the target compound (6).

Alternatively, as the compound (6), a commercially available product as it is may be used, or may be purified as desired for used.

Many of the compounds (7) are publicly known compounds, and may be produced, for example, by appropriately bonding and modifying a plurality of publicly known compounds having a desired structure by any combination of reactions of forming an ether bond (—O—), an ester bond (—C(═O)—O— and —O—C(═O)—), a carbonate bond (—O—C(═O)—O—), and an amide bond (—C(═O)NH— and —NH—C(═O)—).

For example, when the compound (7) is a compound represented by the following formula (7′) (compound (7′)), it may be produced with a dicarboxylic acid represented by the formula (9′) (compound (9′)) in the following manner.

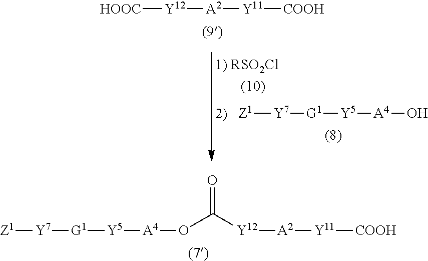

(In the formula, Y⁵, Y⁷, G¹, Z¹, A², A⁴, and Y¹¹ represent the same meanings as the previous descriptions. Y¹² represents a group which allows —O—C(═O)—Y¹² to become Y³. R represents: an alkyl group such as a methyl group and an ethyl group; and an aryl group optionally having a substituent such as a phenyl group and a p-methylphenyl group.)

First, a sulfonyl chloride represented by the formula (10) is reacted with a compound (9′) in the presence of a base such as triethylamine and 4-(dimethylamino)pyridine. Subsequently, to the reaction mixture, a compound (8) and a base such as triethylamine and 4-(dimethylamino)pyridine are added to perform reaction.

The using amount of the sulfonyl chloride is usually 0.5 equivalent to 0.7 equivalent relative to 1 equivalent of the compound (9′).

The using amount of the compound (8) is usually 0.5 equivalent to 0.6 equivalent relative to 1 equivalent of the compound (9′).

The using amount of the base is usually 0.5 equivalent to 0.7 equivalent relative to 1 equivalent of the compound (9′).

The reaction temperature is 20° C. to 30° C., and the reaction time is several minutes to several hours depending on the reaction scale and the like.

Examples of the solvent used in the aforementioned reaction may include those exemplified as the solvent used for producing the compound (4′). In particular, an ether solvent is preferable.

The using amount of the solvent is not particularly limited, and may be set in consideration of the type of the compound used, the reaction scale, and the like. The specific using amount of the solvent is usually 1 g to 50 g. relative to 1 g of the compound (9′).

Regarding any of the reactions, an ordinary post-treatment operation in organic synthetic chemistry may be performed after the end of the reaction. If desired, a target product may be isolated by performing publicly known isolation and purification methods such as column chromatography, recrystallization, and distillation.

The structure of the target compound may be identified by measurement such as NMR spectrometry, IR spectrometry, and mass spectrometry, elemental analysis, and the like.

Among the aforementioned polymerizable liquid crystal compound with reverse wavelength distribution, from the viewpoint of more favorably expressing a desired effect of the present invention, those containing at least one type selected from the group consisting of a benzothiazole ring (the ring of the following formula (11A)); and a combination of a cyclohexyl ring (the ring of the following formula (11B) and a phenyl ring (the ring of the following formula (11C)) in the molecule of the polymerizable liquid crystal compound with reverse wavelength distribution are preferable.

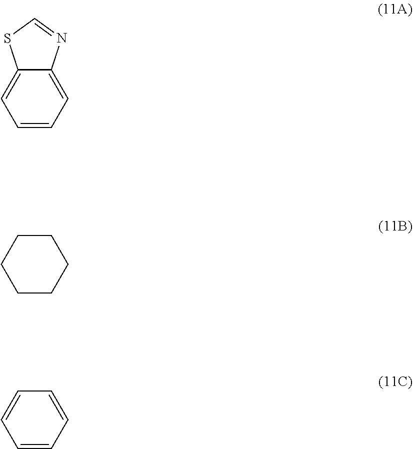 [SMILES: c1ccc2scnc2c1 ; C1CCCCC1 ; c1ccccc1]

[3. Liquid Crystal Composition]

The liquid crystal composition contains the aforementioned polymerizable liquid crystal compound with reverse wavelength distribution. The liquid crystal composition may contain an optional component in combination with the polymerizable liquid crystal compound with reverse wavelength distribution. As these optional components, one type thereof may be solely used, and two or more types thereof may also be used in combination at any ratio.

The liquid crystal composition may contain, for example, a surfactant. The surfactant can improve the coating properties of the liquid crystal composition. Consequently, it is possible to improve the surface state of the liquid crystal cured layer as the layer of the cured product obtained by curing the liquid crystal composition, so that the uniformity in thickness, orientation quality and retardation of the liquid crystal cured layer can be improved.

As the surfactant, a polymerizable surfactant or a surfactant having no polymerizability may be used. Since such a polymerizable surfactant may be polymerized when the polymerizable liquid crystal compound is polymerized, the polymerizable surfactant is usually contained in part of the molecule of the polymer in the liquid crystal curd layer.

As the surfactant, a fluorine-containing surfactant is preferable. Examples of such a surfactant may include SURFLON series manufactured by AGC Seimi Chemical Co., Ltd. (S242, S386, etc.), MEGAFACE series manufactured by DIC Corporation (F251, F554, F556, F562, RS-75, RS-76-E, etc.), and FTERGENT series manufactured by Neos Company Limited (FTX601AD, FTX602A, FTX601ADH2, FTX650A, etc.). As the surfactant, one type thereof may be solely used, and two or more types thereof may also be used in combination at any ratio.

The amount of the surfactant is preferably 0.05 part by weight or more, more preferably 0.1 part by weight or more, and particularly preferably 0.3 part by weight or more, and is preferably 5.0 parts by weight or less, more preferably 1.0 part by weight or less, still more preferably 0.7 part by weight or less, and particularly preferably less than 0.5 part by weight, relative to 100 parts by weight of the polymerizable liquid crystal compound. When the amount of the surfactant is equal to or more than the lower limit value of the aforementioned range, the coating properties of the liquid crystal composition becomes favorable. When the amount is equal to or less than the upper limit value of the aforementioned range, the surface state of the liquid crystal composition can be effectively improved while maintaining the orientation quality.

The liquid crystal composition may contain, for example, a solvent. As the solvent, a solvent capable of dissolving the polymerizable liquid crystal compound with reverse wavelength distribution is preferable. As such a solvent, an organic solvent may usually be used. Examples of the organic solvents may include a ketone solvent such as cyclopentanone, cyclohexanone, methyl ethyl ketone, acetone, and methyl isobutyl ketone; an acetic acid ester solvent such as butyl acetate, and amyl acetate; a halogenated hydrocarbon solvent such as chloroform, dichloromethane, and dichloroethane; an ether solvent such as 1,4-dioxane, cyclopentyl methyl ether, tetrahydrofuran, tetrahydropyran, 1,3-dioxolane, and 1,2-dimethoxyethane; and an aromatic hydrocarbon such as toluene, xylene, and mesitylene.

As the solvent, one type thereof may be solely used, and two or more types thereof may also be used in combination at any ratio. For example, it is preferable to use a combination of a ketone solvent such as cyclopentanone and an ether solvent such as 1,3-dioxolane. When they are combined in this manner, the weight ratio (ketone solvent/ether solvent) of the ketone solvent relative to the ether solvent is preferably 10/90 or more, more preferably 30/70 or more, and particularly preferably 40/60 or more, and is preferably 90/10 or less, more preferably 70/30 or less, and particularly preferably 50/50 or less. By using the ketone solvent and the ether solvent in the above-described weight ratio, it is possible to suppress occurrence of defects at the time of application.

The boiling point of the solvent is preferably 60° C. to 250° C., and more preferably 60° C. to 150° C., from the viewpoint of excellent handling properties.

The amount of the solvent is preferably 300 parts by weight or more, more preferably 350 parts by weight or more, and particularly preferably 400 parts by weight or more, and is preferably 700 parts by weight or less, more preferably 600 parts by weight or less, and particularly preferably 500 parts by weight or less, relative to 100 parts by weight of the polymerizable liquid crystal compound. When the amount of the solvent is equal to or more than the lower limit value of the aforementioned range, it is possible to suppress the generation of impurity matter. When the amount thereof is equal to or less than the upper limit value of the aforementioned range, it is possible to reduce the drying load.

For example, the liquid crystal composition may include a polymerization initiator. The type of the polymerization initiator may be selected according to the type of the polymerizable liquid crystal compound with reverse wavelength distribution. For example, when the polymerizable liquid crystal compound with reverse wavelength distribution is radically polymerizable, a radical polymerization initiator may be used. When the polymerizable liquid crystal compound with reverse wavelength distribution is anionically polymelizable, an anionic polymerization initiator may be used. When the polymerizable liquid crystal compound with reverse wavelength distribution is cationically polymelizable, a cationic polymerization initiator may be used.

As the radical polymerization initiator, there may be used any of: a thermal radical generator which is a compound that generates by heating an active species capable of initiating polymerization of a polymerizable liquid crystal compound with reverse wavelength distribution; and a photo radical generator which is a compound that generates an active species capable of initiating polymerization of a polymerizable liquid crystal compound with reverse wavelength distribution by exposure to light such as visible light, ultraviolet light (such as i rays), far-ultraviolet light, electron beams, and X-rays. Among these, a photo radical generator is suitable as the radical polymerization initiator.

Examples of the photo radical generator may include an acetophenone-based compound, a biimidazole-based compound, a triazine-based compound, an O-acyloxim-based compound, an onium salt-based compound, a benzoin-based compound, a benzophenone-based compound, an α-diketone-based compound, a polynuclear quinone-based compound, a xanthone-based compound, a diazo-based compound, and an imide sulfonate-based compound. These compounds can generate an active radical, an active acid, or both of an active radical and an active acid by exposure to light.

Specific examples of the acetophenone-based compound may include 2-hydroxy-2-methyl-1-phenylpropan-1-one, 2-methyl-1-[4-(methylthio)phenyl]-2-morpholinopropan-1-one, 2-benzyl-2-dimethylamino-1-(4-morpholinophenyl)-butan-1-one, 1-hydroxycyclohexyl.phenylketone, 2,2-dimethoxy-1,2-diphenylethan-1-one, 1,2-octanedione, and 2-benzyl-2-dimethylamino-4′-morpholinobutyrophenone.

Specific examples of the biimidazole-based compound may include 2,2′-bis(2-chlorophenyl)-4,4′,5,5′-tetrakis(4-ethoxycarbonylphenyl)-1,2′-biimidazole, 2,2′-bis(2-bromophenyl)-4,4′,5,5′-tetrakis(4-ethoxycarbonylphenyl)-1,2′-biimidazole, 2,2′-bis(2-chlorophenyl)-4,4′,5,5′-tetraphenyl-1,2′-biimidazole, 2,2′-bis(2,4-dichlorophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 2,2′-bis(2-bromophenyl)-4,4′,5,5′-tetraphenyl-1,2′-biimidazole, 2,2′-bis(2,4-dibromophenyl)-4,4′,5,5′-tetraphenyl-1,2′-biimidazole, and 2,2′-bis(2,4,6-tribromophenyl)-4,4′,5,5′-tetraphenyl-1,2′-biimidazole.

When the biimidazole-based compound is used as a polymerization initiator, a hydrogen donor may be used in combination with the biimidazole-based compound to further improve the sensitivity. Herein, the “hydrogen donor” means a compound which is capable of providing a hydrogen atom to a radical generated from the biimidazole-based compound by exposure to light. As the hydrogen donor, the following examples of a mercaptan-based compound and an amine-based compound are preferable.

Examples of the mercaptan-based compound may include 2-mercaptobenzothiazole, 2-mercaptobenzoxazole, 2-mercaptobenzoimidazole, 2,5-dimercapto-1,3,4-thiadiazole, and 2-mercapto-2,5-dimethylaminopyridine. Examples of the amine-based compound may include 4,4′-bis(dimethylamino)benzophenone, 4,4′-bis(diethylamino)benzophenone, 4-diethylaminoacetophenone, 4-dimethylaminopropiophenone, ethyl-4-dimethylaminobenzoate, 4-dimethylaminobenzoic acid, and 4-dimethylaminobenzonitrile.

Specific examples of the triazine-based compound may include a triazine-based compound having a halomethyl group such as 2,4,6-tris(trichloromethyl)-s-triazine, 2-methyl-4,6-bis(trichloromethyl)-s-triazine, 2-[2-(5-methylfuran-2-yl)ethenyl]-4,6-bis(trichloromethyl)-s-triazine, 2-[2-(furan-2-yl)ethenyl]-4,6-bis(trichloromethyl)-s-triazine, 2-[2-(4-diethylamino-2-methylphenyl)ethenyl]-4,6-bis(trichloromethyl)-s-triazine, 2-[2-(3,4-dimethoxy phenyflethenyl]-4,6-bis(trichloromethyl)-s-triazine, 2-(4-methoxyphenyl)-4,6-bis(trichloromethyl)-s-triazine, 2-(4-ethoxystyryl)-4,6-bis(trichloromethyl)-s-triazine, and 2-(4-n-butoxyphenyl)-4,6-bis(trichloromethyl)-s-triazine.

Specific examples of the O-acyloxim-based compound may include 1-[4-(phenylthio)phenyl]-heptane-1,2-dione 2-(O-benzoyloxim), 1-[4-(phenylthio)phenyl]-octane-1,2-dione 2-(O-benzoyloxim), 1-[4-(benzoyl)phenyl]-octane-1,2-dione 2-(O-benzoyloxim), 1-[9-ethyl-6-(2-methylbenzoyl)-9H-carbazole-3-yl]-ethanone 1-(O-acetyloxim), 1-[9-ethyl-6-(3-methylbenzoyl)-9H-carbazole-3-yl]-ethanone 1-(O-acetyloxim), 1-(9-ethyl-6-benzoyl-9H-carbazole-3-yl)-ethanone 1-(O-acetyloxim), ethanone-1-[9-ethyl-6-(2-methyl-4-tetrahydrofuranylbenzoyl)-9.H.-carbazole-3-yl]-1-(O-acetyloxim), ethanone-1-[9-ethyl-6-(2-methyl-4-tetrahydropyranylbenzoyl)-9.H.-carbazole-3-yl]-1-(O-acetyloxim), ethanone-1-[9-ethyl-6-(2-methyl-5-tetrahydrofuranylbenzoyl)-9.H.-carbazole-3-yl]-1-(O-acetyloxim), ethanone-1-[9-ethyl-6-(2-methyl-5-tetrahydropyranylbenzoyl)-9.H.-carbazole-3-yl]-1-(O-acetyloxim), ethanone-1-[9-ethyl-6-{2-methyl-4-(2,2-dimethyl-1,3-dioxolanyl)benzoyl}-9.H.-carbazole-3-yl]-1-(O-acetyloxim), ethanone-1-[9-ethyl-6-(2-methyl-4-tetrahydrofuranylmethoxybenzoyl)-9.H.-carbazole-3-yl]-1-(O-acetyloxim), ethanone-1-[9-ethyl-6-(2-methyl-4-tetrahydropyranylmethoxybenzoyl)-9.H.-carbazole-3-yl]-1-(O-acetyloxim), ethanone-1-[9-ethyl-6-(2-methyl-5-tetrahydrofuranylmethoxybenzoyl)-9.H.-carbazole-3-yl]-1-(O-acetyloxim), ethanone, 1-[9-ethyl-6-(2-methylbenzoyl)-9H-carbazole-3-yl]-1-(O-acetyloxim), ethanone-1-[9-ethyl-6-(2-methyl-5-tetrahydropyranylmethoxybenzoyl)-9.H.-carbazole-3-yl]-1-(O-acetyloxim), and ethanone-1-[9-ethyl-6-{2-methyl-4-(2,2-dimethyl-1,3-dioxolanyl)methoxybenzoyl}-9.H.-carbazole-3-yl]-1-(O-acetyloxim).

As the photo-radical generator, a commercially available product as it is may be used. Specific examples thereof may include trade name: Irgacure 907, trade name: Irgacure 184, trade name: Irgacure 369, trade name: Irgacure 651, trade name: Irgacure 819, trade name: Irgacure 907, trade name: Irgacure 379, and trade name: Irgacure OXE02, manufactured by BASF Corporation, and trade name: Adecaoptomer N1919, manufactured by ADEKA Corporation.

Examples of the anionic polymerization initiators may include an alkyllithium compound; a monolithium or monosodium salt of, for example, biphenyl, naphthalene, and pyrene; and a polyfunctional initiator such as a dilithium salt and a trilithium salt.

Examples of the cationic polymerization initiators may include a protonic acid such as sulfuric acid, phosphoric acid, perchloric acid, and trifluoromethanesulfonic acid; a Lewis acid such as boron trifluoride, aluminum chloride, titanium tetrachloride, and tin tetrachloride; and an aromatic onium salt or aromatic onium salt in combination with a reductant.

As the polymerization initiator, one type thereof may be solely used, and two or more types thereof may also be used in combination at any ratio.

The amount of the polymerization initiator is preferably 0.1 part by weight or more, and more preferably 0.5 part by weight or more, and is preferably 30 parts by weight or less, and more preferably 10 parts by weight or less, relative to 100 parts by weight of the polymerizable liquid crystal compound. When the amount of the polymerization initiator falls within the aforementioned range, polymerization of the polymerizable liquid crystal compound with reverse wavelength distribution can be efficiently allowed to proceed.

The liquid crystal composition may contain, for example, a polymerizable liquid crystal compound with forward wavelength distribution. Examples of the polymerizable liquid crystal compound with forward wavelength distribution may include rod-shaped liquid crystal compounds described in Japanese Patent Application Laid-Open Nos. 2002-030042 A, 2004-204190 A, 2005-263789 A, 2007-119415 A, 2007-186430 A, and Hei. 11-513360 A. Examples of the product name of the examples of the preferable liquid crystal compound may include “LC242” manufactured by BASF Corporation. As the polymerizable liquid crystal compound with forward wavelength distribution, one type thereof may be solely used, and two or more types thereof may also be used in combination at any ratio.

The amount of the polymerizable liquid crystal compound with forward wavelength distribution is preferably 200 parts by weight or less, more preferably 150 parts by weight or less, and particularly preferably 100 parts by weight or less, relative to 100 parts by weight of the polymerizable liquid crystal compound with reverse wavelength distribution. When the amount of the polymerizable liquid crystal compound with forward wavelength distribution is equal to or less than the aforementioned upper limit value, the advantages such as scratch resistance may not be significantly impaired while the wavelength distribution of the retardation of the liquid crystal cured layer can be adjusted. When the liquid crystal composition contains the polymerizable liquid crystal compound with forward wavelength distribution, the lower limit of the amount of the polymerizable liquid crystal compound with forward wavelength distribution is not particularly limited. For example, the amount of the polymerizable liquid crystal compound with forward wavelength distribution may be 0.1 part by weight relative to 100 parts by weight of the polymerizable liquid crystal compound with reverse wavelength distribution.

Examples of optional components that may be contained in the liquid crystal composition may include additives such as a non-liquid crystal acrylic polymerizable monomer; a metal; a metal complex; a metal oxide such as titanium oxide; a colorant such as a dye or a pigment; a luminescent material such as a fluorescent material or a phosphorescent material; a leveling agent; a thixo agent; a gelling agent; a polysaccharide; an ultraviolet absorber; an infrared absorber; an antioxidant; and an ion exchange resin. One type of these may be solely used, and two or more types thereof may also be used in combination at any ratio.

The amount of the additive may be freely set within a range that does not significantly impair the advantageous effects of the present invention. Specifically, the amount of the additive may be 0.1 part by weight to 20 parts by weight relative to 100 parts by weight of the polymerizable liquid crystal compound.

[4. Liquid Crystal Cured Layer]

The liquid crystal cured layer is a layer formed of the cured product of the liquid crystal composition described above. With regard to the liquid crystal cured layer, the peak ratio X of two surfaces (front and back surfaces) perpendicular to the thickness direction of the liquid crystal cured layer satisfies the expression (i). Specifically, X(S)/X(A) is usually more than 1.00 and preferably more than 1.05, and is preferably less than 1.30 and more preferably less than 1.25. When X(S)/X(A) is more than the lower limit value of the aforementioned range, the scratch resistance of the liquid crystal cured layer can be improved, and the adhesive resistance and peeling properties of the liquid crystal cured layer can be usually improved. When X(S)/X(A) is less than the upper limit value of the aforementioned range, a decrease in durability caused by a change of the liquid crystal cured layer due to aging can be suppressed.

The peak ratios X(S) and X(A) may be measured by the following method.

The IR spectrum of the surface of the liquid crystal cured layer of the liquid crystal cured film is measured. From the measured IR spectrum, the peak strength I(1) at 1407.7809 cm⁻¹ derived from the in-plane deformation vibration of the ethylenically unsaturated bond and the peak strength I(2) at 1505.1685 cm⁻¹ derived from the stretching vibration of the unsaturated bond of the aromatic ring are determined. From the peak strengths I(1) and I(2), the peak ratios X(S) and X(A) of each surface of the liquid crystal cured layer are calculated.

Examples of a method for realizing the liquid crystal cured layer satisfying the expression (i) may include selection of type of polymerizable liquid crystal compound, selection of type of polymerization initiator, and irradiation of the surface on the air side of the layer of the liquid crystal composition with an active energy ray such as ultraviolet light during the curing of the liquid crystal composition. In general, polymerization is inhibited on the surface on the air side of the liquid crystal composition due to oxygen in the air. Therefore, it is difficult to make the polymerization reaction proceed at a high level. Even when the liquid crystal composition is cured under an inert atmosphere such as nitrogen, it is difficult to completely eliminate oxygen in the atmosphere. Therefore, it is difficult to eliminate all influences of inhibition of polymerization by oxygen. Therefore, the irradiation of the surface on the air side of the layer of the liquid crystal composition with an active energy ray does not always result in the polymerization reaction achievement at a high level on the surface on the air side of the layer of the liquid crystal composition. Accordingly, in order to achieve the expression (i), a combination of selection of an appropriate type of polymerization initiator depending on the type of the polymerizable liquid crystal compound with reverse wavelength distribution and irradiation of the surface on the air side of the layer of the liquid crystal composition with an active energy ray is preferable.

As described above, the degree of progression of the polymerization reaction of the polymerizable liquid crystal compound with reverse wavelength distribution contained in the liquid crystal cured layer varies in the thickness direction. Therefore, the ratio of the polymerizable liquid crystal compound with reverse wavelength distribution contained in the liquid crystal cured layer varies depending on positions in the thickness direction, and has a distribution. However, even in such a liquid crystal cured layer, it is preferable that the average ratio of the polymerizable liquid crystal compound with reverse wavelength distribution in the entire thickness direction is equal to or less than a specific value. Hereinafter, the average ratio of the polymerizable liquid crystal compound with reverse wavelength distribution contained in the liquid crystal cured layer may be referred to as “residual monomer ratio” as appropriate. The specific value of residual monomer ratio of the liquid crystal cured layer is preferably 40% by weight or less, and more preferably 30% by weight or less. When the residual monomer ratio of the liquid crystal cured layer is equal to or less than the upper limit value, curing of the liquid crystal cured layer is sufficiently achieved. Therefore, the scratch resistance and adhesive resistance of the liquid crystal cured layer can be effectively improved.

The residual monomer ratio of the liquid crystal cured layer may be measured by extracting the polymerizable liquid crystal compound with reverse wavelength distribution from the liquid crystal cured layer to obtain an extracted solution, and quantifying the amount of the polymerizable liquid crystal compound with reverse wavelength distribution in the extracted solution. The quantification of the polymerizable liquid crystal compound with reverse wavelength distribution in the extracted solution may be performed by high performance liquid chromatography (HPLC).

When the liquid crystal composition contains a surfactant, the liquid crystal cured layer produced from the liquid crystal composition usually contains the surfactant. In this case, the amount of the surfactant on one of the surfaces of the liquid crystal cured layer may be smaller than the amount of the surfactant on the other surface of the liquid crystal cured layer. In the liquid crystal composition, the surfactant tends to often concentrate at an air interface. Therefore, the aforementioned one surface of the liquid crystal cured layer corresponds to a surface on the substrate film side used in formation of the liquid crystal cured layer, and the other surface of the liquid crystal cured layer corresponds to a surface on a side opposite to the substrate film. Accordingly, which surface of the liquid crystal cured layer is the surface on the substrate film side of the liquid crystal cured layer in the liquid crystal cured film from which the substrate film has been peeled off can be confirmed by measuring the amount of the surfactant on the surface of the liquid crystal cured layer.

The fact that the amount of the surfactant on the one surface of the liquid crystal cured layer is smaller than the amount of the surfactant on the other surface of the liquid crystal cured layer may be confirmed by measuring the ratio of amounts of the surfactant on the aforementioned one surface and the other surface. Instead of measurement of the ratio of amounts of the surfactant, the ratio of amounts of specific atom contained in the surfactant may be measured. The amount of specific atom on the surface of the liquid crystal cured layer may be measured by an X-ray photoelectron spectroscopy (XPS) as the numeric containing ratio of the specific atom contained in all atoms except for hydrogen (H). For example, when the surfactant contains a fluorine atom as the specific atom and the ratio f1/f2 of the containing ratio f1 of the fluorine atom on the other surface of the liquid crystal cured layer relative to the containing ratio f2 of the fluorine atom on the one surface of the liquid crystal cured layer is confirmed to be larger than 1.0, it can be judged that the amount of the surfactant on the one surface of the liquid crystal cured layer is smaller than the amount of the surfactant on the other surface of the liquid crystal cured layer.

The polymer of the polymerizable liquid crystal compound with reverse wavelength distribution contained in the liquid crystal cured layer is usually a product obtained by polymerizing the polymerizable liquid crystal compound with reverse wavelength distribution with the orientation state thereof being maintained. Therefore, when the polymerizable liquid crystal compound with reverse wavelength distribution contained in the liquid crystal composition is oriented, the polymer obtained from the polymerizable liquid crystal compound with reverse wavelength distribution may be a polymer with the orientation of molecules of the polymerizable liquid crystal compound with reverse wavelength distribution in the liquid crystal phase being maintained. Accordingly, the polymer may have homogeneous orientation regularity. Herein, “having homogeneous orientation regularity” means that long-axis directions of mesogens of molecules of the polymer are aligned in a certain direction parallel to the surface of the liquid crystal cured layer. The long-axis directions of mesogens of molecules of the polymer are the long-axis direction of mesogen of the polymerizable liquid crystal compound with reverse wavelength distribution that corresponds to the polymer. When the liquid crystal cured layer includes a plurality of types of mesogens having different orientation directions such as a case of using the compound (I) as the polymerizable liquid crystal compound with reverse wavelength distribution, the aforementioned alignment direction is a direction in which mesogens having the longest length among the mesogens are aligned.

Such a liquid crystal cured layer usually has a slow axis that is parallel to the alignment direction of the aforementioned polymer according to the orientation regularity of the polymer. The presence or absence of homogeneous orientation regularity of the polymer obtained by polymerizing the polymerizable liquid crystal compound with reverse wavelength distribution and the alignment direction thereof may be confirmed by measurement of the slow axis direction using a phase difference meter typified by AxoScan (manufactured by Axometrics, Inc.) and measurement of retardation distribution of each incidence angle in the slow axis direction.

The slow axis direction of the liquid crystal cured layer may be optionally set according to the applications of the liquid crystal cured film. For example, it is preferable that the liquid crystal cured layer of a liquid crystal cured film having a long-length shape such as the liquid crystal cured layer produced using the long-length substrate has a slow axis at an angle of 40° to 50° relative to the lengthwise direction of the liquid crystal cured film. A linear polarizer is usually produced as a long-length film having an absorption axis parallel to the lengthwise direction of the linear polarizer and a transmission axis perpendicular to the lengthwise direction. When the liquid crystal cured layer has a slow axis at an angle of 40° to 50° relative to the lengthwise direction of the liquid crystal cured film, a circularly polarizing plate including the linear polarizer and the liquid crystal cured layer can be easily produced by a roll-to-roll method.

When the polymer of the polymerizable liquid crystal compound with reverse wavelength distribution contained in the liquid crystal cured layer is oriented, the liquid crystal cured layer has a retardation in accordance with the orientation state. The specific range of the retardation of the liquid crystal cured layer may be optionally set depending on the application. For example, when it is desired that the liquid crystal cured layer functions as a ¼ wave plate, the retardation Re of the liquid crystal cured layer at the measurement wavelength of 590 nm is preferably 90 nm or more, more preferably 110 nm or more, and particularly preferably 130 nm or more, and is preferably 190 nm or less, more preferably 170 nm or less, and particularly preferably 160 nm or less. Further, for example, when it is desired that the liquid crystal cured layer functions as a ½ wave plate, the retardation Re of the liquid crystal cured layer at the measurement wavelength of 590 nm is preferably 265 nm or more, more preferably 285 nm or more, and particularly preferably 290 nm or more, and is preferably 325 nm or less, more preferably 305 nm or less, and particularly preferably 300 nm or less.

Since the liquid crystal cured layer contains the polymer obtained by polymerizing the polymerizable liquid crystal compound with reverse wavelength distribution, the liquid crystal cured layer has birefringence with reverse wavelength distribution. Therefore, the liquid crystal cured layer can have a retardation with reverse wavelength distribution. Herein, the retardation with reverse wavelength distribution refers to a retardation in which a retardation Re(450) at a wavelength of 450 nm, a retardation Re(550) at a wavelength of 550 nm, and a retardation Re(650) at a wavelength of 650 nm usually satisfy the following expression (v), and preferably the following expression (vi). When the liquid crystal cured layer has a retardation with reverse wavelength distribution, the liquid crystal cured layer can uniformly express a function over a wide bandwidth for optical applications such as a ¼ wave plate or a ½ wave plate.

Re(450)<Re(650) (v)

Re(450)<Re(550)<Re(650) (vi)

The thickness of the liquid crystal cured layer may be appropriately set so that properties such as a retardation can fall within a desired range. Specifically, the thickness of the liquid crystal cured layer is preferably 0.5 μm or more and more preferably 1.0 μm or more, and is preferably 10 μm or less and more preferably 7 μm or less.

[5. Substrate Film]

The liquid crystal cured film may include a substrate film that has been used for formation of the liquid crystal cured layer. As such a substrate film, a resin film is usually used. Examples of the resin may include resins containing various types of polymers. Example of the polymers may include an alicyclic structure-containing polymer such as a norbornene-based polymer, a cellulose ester, a polyvinyl alcohol, a polyimide, UV-transmitting acrylic, a polycarbonate, a polysulfone, a polyether sulfone, an epoxy polymer, a polystyrene, and a combination thereof. Among these, an alicyclic structure-containing polymer and a cellulose ester are preferable, and an alicyclic structure-containing polymer is more preferable from the viewpoint of transparency, low hygroscopicity, size stability, and light weight properties.

In order to promote orientation of the polymerizable liquid crystal compound with reverse wavelength distribution in the layer of the liquid crystal composition, the substrate film may have been subjected to a treatment of imparting an orientation regulating force to the surface of the substrate film. Herein, the orientation regulating force of a surface means properties of the surface that is capable of giving orientation to the polymerizable liquid crystal compound with reverse wavelength distribution in the liquid crystal composition.

Examples of the treatment of imparting an orientation regulating force may include a rubbing treatment. When the rubbing treatment is performed on a surface of the substrate film, an orientation regulating force of homogeneously giving orientation to the polymerizable liquid crystal compound with reverse wavelength distribution can be imparted to the surface. Examples of the method for rubbing treatment may include a method in which the surface of the substrate film is rubbed in a constant direction with a roll wrapped with cloth or felt formed of synthetic fibers such as nylon or natural fibers such as cotton. In order to remove minute powders generated during the rubbing treatment to make the treated surface clean, it is preferable that the treated surface is cleaned after the rubbing treatment with a cleaning liquid such as isopropyl alcohol.

Examples of the treatment of imparting an orientation regulating force may also include a treatment of forming an orientation layer on the surface of the substrate film. The orientation layer is a layer on which the polymerizable liquid crystal compound with reverse wavelength distribution in the liquid crystal composition may be oriented in one direction in the plane. When the orientation layer is provided, the liquid crystal cured layer may be formed on a surface of the orientation layer.

The orientation layer usually contains a polymer such as a polyimide, a polyvinyl alcohol, a polyester, a polyarylate, a polyamideimide, and a polyetherimide. The orientation layer may be produced by applying a solution containing such a polymer onto the substrate film in a film shape, drying the solution, and performing a rubbing treatment in one direction. As the method other than the rubbing treatment, a method of irradiating the surface of the orientation layer with polarized ultraviolet light may also impart an orientation regulating force to the orientation layer. The thickness of the orientation layer is preferably 0.001 μm to 5 μm, and more preferably 0.001 μm to 1 μm.

Examples of the treatment of imparting an orientation regulating force may also include a stretching treatment. When a stretching treatment is performed under conditions suitable for the substrate film, molecules of the polymer contained in the substrate film can be oriented. Thus, an orientation regulating force of giving orientation to the polymerizable liquid crystal compound with reverse wavelength distribution in an orientation direction of molecules of the polymer contained in the substrate film can be imparted to the surface of the substrate film.

It is preferable that the stretching of the substrate film is performed whereby anisotropy is imparted to the substrate film and the substrate film can thereby express a slow axis. Thereby an orientation regulating force of giving orientation to the polymerizable liquid crystal compound with reverse wavelength distribution in a direction parallel or perpendicular to the slow axis of the substrate film is usually imparted to the surface of the substrate film. For example, when a resin having a positive intrinsic birefringence value is used as a material for the substrate film, orientation of the molecules of the polymer contained in the substrate film in a stretching direction usually results in expression of a slow axis parallel to the stretching direction. Therefore, the orientation regulating force of giving orientation to the polymerizable liquid crystal compound with reverse wavelength distribution in the direction parallel to the slow axis of the substrate film is imparted to the surface of the substrate film. Accordingly, the stretching direction of the substrate film may be set according to a desired orientation direction in which the polymerizable liquid crystal compound with reverse wavelength distribution is to be oriented. In particular, it is preferable that the slow axis of the substrate film is expressed at an angle of 40° to 50° relative to a winding direction of the substrate film. Herein, the winding direction of the substrate film is a direction in which a long-length substrate film is wound, and usually means a direction parallel to the lengthwise direction of the substrate film.

The stretching ratio may be set so that the birefringence Δn of the substrate film after stretching falls within a desired range. The birefringence Δn of the substrate film after stretching is preferably 0.000050 or more and more preferably 0.000070 or more, and is preferably 0.007500 or less and more preferably 0.007000 or less. When the birefringence Δn of the substrate film after stretching is equal to or more than the lower limit value of the aforementioned range, a favorable orientation regulating force can be imparted to the surface of the substrate film. When the birefringence Δn is equal to or less than the upper limit value of the aforementioned range, the retardation of the substrate film can be decreased. Therefore, the liquid crystal cured film including the liquid crystal cured layer and the substrate film in combination without peeling the substrate film from the liquid crystal cured layer may be used for a variety of applications.

The stretching may be performed by using a stretching machine such as a tenter stretching machine.

Examples of the treatment for imparting an orientation regulating force may include an ion beam orientation treatment. In the ion beam orientation treatment, an ion beam of Ar⁺ or the like is made incident on the substrate film, and thereby an orientation regulating force can be imparted to the surface of the substrate film.

The thickness of the substrate film is not particularly limited, and is preferably 1 μm or more, more preferably 5 μm or more, and particularly preferably 30 μm or more, and is preferably 1,000 μm or less, more preferably 300 μm or less, and particularly preferably 100 μm or less from the viewpoint of enhancing productivity and facilitating thickness reduction and weight reduction.

[6. Optional Layer]

The liquid crystal cured film may have an optional layer other than the substrate film disposed on the above-described liquid crystal cured layer. For example, the liquid crystal cured film may have an optional layer disposed on an opposite surface of the liquid crystal cured layer to the substrate film. Examples of the optional layer may include an adhesive layer for effecting adhesion to another member, a mat layer for improving the sliding properties of the film, a hardcoat layer such as an impact-resistant polymethacrylate resin layer, an anti-reflection layer, and an anti-fouling layer.

[7. Properties of Liquid Crystal Cured Film]

The liquid crystal cured film may preferably have properties suitable for the intended applications. For example, when the liquid crystal cured film is used as an optical film, the liquid crystal cured film can have a retardation falling within the same range as that described as the range of the retardation Re which the liquid crystal cured layer may have.

When the liquid crystal cured film is used as an optical film, the optical film may preferably have a high transparency. Specifically, the total light transmittance of the liquid crystal cured film is preferably 70% or more, more preferably 80% or more, and particularly preferably 90% or more. The haze of the liquid crystal cured film is preferably 10% or less, more preferably 5% or less, and particularly preferably 3% or less. The total light transmittance of the film may be measured in the wavelength range of 400 nm to 700 nm using an ultraviolet-visible spectrometer. The haze of the film may be measured using a haze meter.

[8. Method for Producing Liquid Crystal Cured Film]

The liquid crystal cured film described above may be produced by a production method including a step of forming a layer of a liquid crystal composition on a substrate film; and a step of curing the layer of the liquid crystal composition to obtain a liquid crystal cured layer.

In this production method, a substrate film is prepared, and a layer of a liquid crystal composition is formed on the surface of the substrate film. As described above, the surface of the substrate film may have been subjected to a treatment for imparting an orientation regulating force. As the substrate film, it is preferable to use a long-length film. The “long-length” herein means a shape having a length that is 5 times or more the width and preferably 10 times or more the width, and specifically means a shape of a film having such a length that the film can be wound up into a roll shape for storage or conveyance.

The upper limit of the length of the long-length substrate film is not particularly limited, and for example, may be 10,000 times or less the width. Use of the long-length substrate film can improve the productivity of the liquid crystal cured film.

The formation of the layer of the liquid crystal composition may be usually performed by a coating method. Specifically, the layer of the liquid crystal composition may be formed by applying the liquid crystal composition onto a surface of the substrate film. Examples of the application methods may include a curtain coating method, an extrusion coating method, a roll coating method, a spin coating method, a dip coating method, a bar coating method, a spray coating method, a slide coating method, a printing coating method, a gravure coating method, a die coating method, a gap coating method, and a dipping method. The thickness of the layer of the liquid crystal composition to be applied may be appropriately set according to a desired thickness required for the liquid crystal cured layer.

After the layer of the liquid crystal composition is formed, the step of orienting the polymerizable liquid crystal compound with reverse wavelength distribution contained in the layer is performed as necessary. In this step, by subjecting the layer of the liquid crystal composition to an orientation treatment, the polymerizable liquid crystal compound with reverse wavelength distribution may usually be oriented in a direction corresponding to the orientation regulating force of the surface of the substrate film. The orientation treatment is usually performed by heating the layer of the liquid crystal composition at a specific orientation temperature. The conditions for the orientation treatment may be appropriately set according to the properties of the liquid crystal composition to be used. Specifically, the conditions for the orientation treatment may be conditions of treatment for 30 seconds to 5 minutes under a temperature condition of 50° C. to 160° C.

However, the orientation of the polymerizable liquid crystal compound with reverse wavelength distribution may be achieved immediately by applying the liquid crystal composition. Therefore, even if the polymerizable liquid crystal compound with reverse wavelength distribution is desired to be oriented, the orientation treatment may not be necessarily performed on the layer of the liquid crystal composition.

After the polymerizable liquid crystal compound with reverse wavelength distribution is oriented as necessary, the step of curing the layer of the liquid crystal composition to obtain a liquid crystal cured layer is performed. In this step, the polymerizable liquid crystal compound with reverse wavelength distribution is polymerized to cure the layer of the liquid crystal composition. As the method for polymerizing the polymerizable liquid crystal compound with reverse wavelength distribution, a method suitable for the properties of components contained in the liquid crystal composition may be selected. Examples of the polymerization method may include an irradiation method with an active energy ray and a thermal polymerization method. Among these, the irradiation method with an active energy ray is preferable since a polymerization reaction can proceed at room temperature without heating. Herein, the active energy ray for irradiation may include light such as visible light, ultraviolet light, and infrared light, and any energy ray such as an electron beam.

In particular, an irradiation method with light such as ultraviolet light is preferable since the operation is simple. The temperature during irradiation with ultraviolet light is preferably equal to or lower than the glass transition temperature of the substrate film. The temperature is preferably 150° C. or lower, more preferably 100° C. or lower, and particularly preferably 80° C. or lower. The lower limit of temperature during irradiation with ultraviolet light may be 15° C. or higher. The irradiation intensity of ultraviolet light is preferably 0.1 mW/cm² or more and more preferably 0.5 mW/cm² or more, and is preferably 1,000 mW/cm² or less and more preferably 600 mW/cm² or less.

The liquid crystal cured film including the liquid crystal cured layer and the substrate film may be obtained by curing the layer of the liquid crystal composition to form the liquid crystal cured layer.

The method for producing a liquid crystal cured film may include any optional steps in addition to the aforementioned steps.

For example, the method for producing a liquid crystal cured film may include a step of drying the layer of the liquid crystal composition before the step of polymerizing the polymerizable liquid crystal compound with reverse wavelength distribution. Such drying may be achieved by a drying method such as natural drying, drying under heating, drying under reduced pressure, and drying under heating and reduced pressure. By the drying, the solvent can be removed from the layer of the liquid crystal composition.

For example, the method for producing a liquid crystal cured film may include a step of peeling the substrate film from the produced liquid crystal cured film.

The method for producing a liquid crystal cured film may further include a step of, for example, providing an optional layer to the produced liquid crystal cured film.

[9. Application of Liquid Crystal Cured Film]

The application of the liquid crystal cured film is optional. The liquid crystal cured film may preferably be used as an optical film.

Examples of suitable optical film may include wave plates such as a ¼ wave plate and a ½ wave plate. As the aforementioned wave plates, a liquid crystal cured film including only the liquid crystal cured layer may be adopted. Such a wave plate having only the liquid crystal cured layer may be produced, for example, by peeling the liquid crystal cured layer formed on the substrate film from the substrate film and cutting the liquid crystal cured layer into a desired shape according to applications, such as a rectangle. As the aforementioned wave plate, a liquid crystal cured film further including the substrate film used in formation of the liquid crystal cured layer in combination with the liquid crystal cured layer may be adopted. For example, as the wave plate, a liquid crystal cured film having a multilayer structure including the substrate film and the liquid crystal cured layer as it is may be used without peeling the liquid crystal cured layer formed on the substrate film from the substrate film. The aforementioned wave plate may have an optional layer in addition to the liquid crystal cured layer and the substrate film.

Another example of suitable optical films may be a circularly polarizing plate. The circularly polarizing plate includes a linear polarizer and the aforementioned liquid crystal cured layer.

As the linear polarizer, any linear polarizer used in a device such as a liquid crystal display device may be used. Examples of the linear polarizer may include those obtained by giving a polyvinyl alcohol film an absorption treatment with iodine or dichromatic dye and then uniaxially stretching the polyvinyl alcohol film in a boric acid bath; and those obtained by giving a polyvinyl alcohol film an absorption treatment with iodine or dichromatic dye, stretching the polyvinyl alcohol film, and then modifying a part of polyvinyl alcohol units in the molecular chain thereof into polyvinylene units. Other examples of the linear polarizer may include a polarizer having a function of separating polarized light into reflected light and transmitted light, such as a grid polarizer, a multi-layer polarizer, and a cholesteric liquid crystal polarizer. Among these, a polarizer containing polyvinyl alcohol is preferable.

When natural light is incident on the linear polarizer, only one polarized light is transmitted. The degree of polarization of the linear polarizer is preferably 98% or more and more preferably 99% or more. The average thickness of the linear polarizer is preferably 5 μm to 80 μm.

It is preferable that the liquid crystal cured layer has such an appropriate retardation that it may function as a ¼ wave plate. The angle formed between the slow axis of the liquid crystal cured layer and a transmission axis of the linear polarizer is preferably 45° or an angle close to 45° as viewed in the thickness direction, and specifically preferably 40° to 50°.

The circularly polarizing plate may further include an optional layer, in addition to the linear polarizer and the liquid crystal cured layer.

One of applications of such a circularly polarizing plate may be an application as an anti-reflective film for a display device such as an organic electroluminescent display device. When the circularly polarizing plate is provided to the surface of a display device such that the surface on the linear polarizer side faces the viewing side, light which enters from the outside of the device can be prevented from exiting the device after reflection in the device. As a result, glare on the display surface of the display device can be suppressed. Specifically, only part of the linearly polarized light of the light having entered from the outside of the device passes through the liner polarizer, and subsequently passes through the liquid crystal cured layer, to thereby become circularly polarized light. The circularly polarized light is reflected on a constituent element which permits the light in the device to be reflected thereon (such as a reflective electrode), and thereafter passes through the liquid crystal cured layer again. In this manner, the light becomes linearly polarized light having its polarizing axis in a direction orthogonal to the polarizing axis of the incident linearly polarized light. Accordingly, the linearly polarized light does not pass through the linear polarizer. Accordingly, the anti-reflection function is achieved.

### EXAMPLES

Hereinafter, the present invention will be specifically described by illustrating Examples. However, the present invention is not limited to the Examples described below. The present invention may be optionally modified for implementation without departing from the scope of claims of the present invention and the scope of their equivalents. In the following description, “%” and “part” representing quantity are on the basis of weight, unless otherwise specified. The operation described below was performed under the conditions of normal temperature and normal pressure in an atmospheric air, unless otherwise specified.

[Evaluation Method]

[1. Method for Measuring IR spectrum]

A surface on an air side of the liquid crystal cured layer of the liquid crystal cured film was bonded to a resin film (“ZEONOR film” manufactured by ZEON Corporation) using a tackiness agent. Subsequently, the substrate film was peeled off, and a surface on the substrate film side of the liquid crystal cured layer was exposed. Using this sample thus obtained including the resin film and the liquid crystal cured layer, the IR spectrum of the surface on the substrate film side of the liquid crystal cured layer was measured

On the other hand, the IR spectrum of the surface on the air side of the liquid crystal cured layer was measured using the liquid crystal cured film itself as a sample.

In measurement of IR spectrum, a Fourier transform infrared spectrophotometer (“FTIR 4100” manufactured by JASCO Corporation) was used. This measurement was performed at an incident angle of 45° by using a jig (“ATR-PRO450-S” manufactured by JASCO Corporation) that is an equipment of the Fourier transform infrared spectrophotometer.

From the measured IR spectrum, the peak strength I(1) at 1407.7809 cm⁻¹ derived from the in-plane deformation vibration of an ethylenically unsaturated bond and the peak strength I(2) at 1505.1685 cm⁻¹ derived from the stretching vibration of an unsaturated bond of an aromatic ring were determined.

[2. Rubbing Test Method]

The haze of the liquid crystal cured film was measured by using a haze meter (“HAZE-GARD II” manufactured by Toyo Seiki Seisaku-sho, Ltd.).

After that, the surface on the air side of the liquid crystal cured layer of the liquid crystal cured film was subjected to a rubbing test by rubbing the film with application of a load of 50 g via a non-woven fabric made from lyocell (diameter: 12 mm, “TRISEPTA” manufactured by GUARDNER Co., Ltd.) using a surface property measurement device (“HEIDON TRIBOGEAR type38” manufactured by Shinto Scientific Co., Ltd.). The rubbing conditions were a rate of moving the non-woven fabric of 2,000 mm/min, a moving distance of the non-woven fabric of 30 mm, and the rubbing number by the non-woven fabric of 30 cycles.

After the rubbing test, the haze of the liquid crystal cured film at a portion that had been rubbed by the non-woven fabric was measured using the haze meter.

The haze before the rubbing test was subtracted from the haze after the rubbing test, to determine the haze change amount Δhaze (%).

[3. Method for Evaluating Adhesive Resistance]

7 Parts of “2-hydroxy-3-acryloyloxypropyl methacrylate” that was a (meth)acrylate monomer containing a hydroxyl group in the molecule, 90 parts of “3-methyl-1,5-pentanediol diacrylate” that was an acrylate monomer containing no hydroxyl group, and 3 parts of a photopolymerization initiator (“Irgacure 2959” manufactured by BASF Corporation) were taken up, sufficiently stirred, and sufficiently degassed. As a result, an ultraviolet-curable adhesive was obtained.

The in-plane retardation Re₀ of the liquid crystal cured film at a measurement wavelength of 590 nm was measured using a phase difference meter (“Axoscan” manufactured by Axometrics, Inc.; cumulated number: 20).

Subsequently, the aforementioned ultraviolet-curable adhesive was applied onto the surface on the air side of the liquid crystal cured layer of the liquid crystal cured film so that the thickness was 100 μm or more, to obtain a layered body including a substrate film, the liquid crystal cured layer, and an adhesive layer.

Five minutes after the time point of applying the adhesive onto the liquid crystal cured layer, the in-plane retardation Re₁ of the layered body at a measurement wavelength of 590 nm was measured by using the aforementioned phase difference meter.

The in-plane retardation changing amount ΔRe was calculated by the following expression (ii) from the obtained in-plane retardations Re₀ and Re₁.

ΔRe={(Re₀−Re₁)/Re₀}×100(%) (ii)

Smaller absolute value of in-plane retardation changing amount ΔRe is indicative of better resistance to the adhesive of the liquid crystal cured layer.

[4. Method for Evaluating Transferability]

The liquid crystal cured film was cut out to obtain a sample in a shape of 2 cm×5 cm. The surface on an air side of the liquid crystal cured layer of the sample was bonded to a resin film (“ZEONOR film” manufactured by ZEON Corporation) using a tackiness agent. Subsequently, the substrate film was peeled off, and the peeled substrate film was observed.

When the liquid crystal cured layer was not attached to the entire of the peeled substrate film, the transferability was judged to be “good”. When a part of the liquid crystal cured layer was attached to the peeled substrate film, the transferability was judged to be “poor”.

[5. Method for Measuring Residual Monomer Ratio of Liquid Crystal Cured Layer]

The liquid crystal compound used in each of Examples and Comparative Examples was dissolved in 1,3-dioxolane as a solvent, to obtain solutions having various concentrations for drawing up a calibration curve. These solutions were analyzed by a general-purpose HPLC (“Prominence” manufactured by Shimadzu Corporation), to draw up a calibration curve.

From the liquid crystal cured film, about 20 mg of only the liquid crystal cured layer was collected, added to 1.5 g of 1,3-dioxolane, and allowed to stand for 8 hours, to extract the liquid crystal compound that was a residual monomer. The obtained extract was filtered through a disk filter with a pore diameter of 0.45 μm and analyzed by the aforementioned general-purpose HPLC. The analysis result was compared with the aforementioned calibration curve to thereby determine the concentration of the liquid crystal compound in the extract, and the residual monomer ratio was calculated.

Analysis conditions for HPLC were as follows.

Solvent: acetonitrile

Flow rate: 1 mL/min

Used column: Eclipse XDB-C18 (manufactured by Agilent)

[6. Method for Measuring Ratio of Surfactant Amount by Surface Elemental Analysis]

The containing ratio (%: numeric percentage of atoms) f1 of fluorine on the surface on the air side of the liquid crystal cured layer was measured using the liquid crystal cured film itself as a sample under the following conditions by an X-ray photoelectron spectroscopy.

The surface on the air side of the liquid crystal cured layer of the liquid crystal cured film was bonded to an electroconductive carbon tape using a tackiness agent. Subsequently, the substrate film was peeled off, and a surface on the substrate film side of the liquid crystal cured layer was exposed. The containing ratio (%: numeric percentage of atoms) f2 of fluorine on the surface on the substrate film side of the liquid crystal cured layer was measured using the sample including the electroconductive carbon tape and the liquid crystal cured layer under the following conditions by an X-ray photoelectron spectroscopy.

System: “AXIS ULTRA” manufactured by Kratos Analytical Ltd

Exited X ray: A1 Kα ray

Filament emission: 10 mA

Anode HT: 15 kV

Neutralization gun: Electron Neutralizer

Neutralization condition:
Filament current: 1.55 A
Charge balance: 3.3 V
Filament bias: 1.5 V

Analysis area: about 700 μm×300 μm

Photoelectron detection angle: 0° (angle between sample surface and detector: 90°)

The ratio f1/f2 of the containing ratio f1 of fluorine on the surface on the air side of the liquid crystal cured layer relative to the containing ratio f2 of fluorine on the surface on the substrate film side of the liquid crystal cured layer was calculated. The surfactant used in Examples and Comparative Examples described below contained a fluorine atom in the molecule. Therefore, the containing ratios f1 and f2 of fluorine corresponded to the amount of surfactant on the surface of the liquid crystal cured layer. Accordingly, the value of the ratio f1/f2 being larger than 1.0 is indicative that the amount of the surfactant on the surface on the substrate film side of the liquid crystal cured layer is smaller than the amount of the surfactant on the surface on the air side of the liquid crystal cured layer.

### Production Example 1. Production of Substrate Film

Pellets of a thermoplastic norbornene resin (“ZEONOR 1420R” manufactured by ZEON Corporation) were dried at 90° C. for 5 hours. The dried pellets were supplied to an extruder, melted in the extruder, passed through a polymer pipe and a polymer filter, and extruded from a T-die on a casting drum in a form of a film. The film was cooled to produce a long-length pre-stretch substrate having a thickness of 60 μm and a width of 1,490 mm. The produced pre-stretch substrate was wound to obtain a roll.

The aforementioned pre-stretch substrate was unwound from the roll, and supplied to a tenter stretching machine. The pre-stretch substrate was stretched by using the tenter stretching machine so that an angle of the slow axis of the stretched substrate to be obtained after stretching was 45° relative to the winding direction of stretched substrate. Both ends of the substrate in a widthwise direction of the film were trimmed, and the film was wound, to thereby obtain a long-length stretched substrate having a width of 1,350 mm as a substrate film. The thickness of the obtained substrate film was 47 μm.

### Example 1

### (1.1. Production of Liquid Crystal Composition)

100 Parts by weight of a polymerizable liquid crystal compound with reverse wavelength distribution (E1) having a structure represented by the following formula (E1), 0.3 parts by weight of a surfactant (“F562” manufactured by DIC Corporation), and 3 parts by weight of a photopolymerization initiator (“IRGACURE 379EG” manufactured by BASF Corporation) were mixed in 146.5 parts by weight of cyclopentanone and 219.8 parts by weight of 1,3-dioxolane as solvents, and completely dissolved. The resulting mixed solution was filtered through a disk filter having a pore diameter of 0.45 μm to produce a liquid crystal composition in a liquid state.

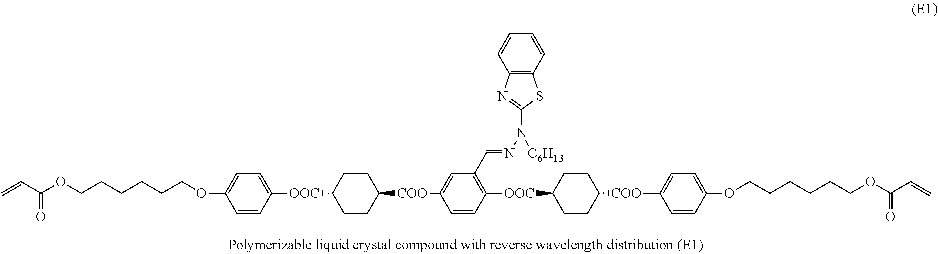

(Production of Liquid Crystal Cured Film)

The liquid crystal composition was applied onto the substrate film produced in Production Example 1 by using a wire bar (#6), to form a layer of the liquid crystal composition. The layer of the liquid crystal composition was heated in an oven (“Inert oven DN410I” manufactured by Yamato Scientific Co., Ltd.) at a temperature of 110° C., which was equal to or higher than the liquid crystal temperature of the liquid crystal compound, for 4 minutes. Thus, a drying treatment and an orientation treatment were performed.

Subsequently, the surface on the air side of the layer of the liquid crystal composition was irradiated with ultraviolet light under a nitrogen atmosphere by using a conveyor UV radiation device (manufactured by Eye Graphics Co., Ltd., high-pressure mercury lamp, output: 4 kW, lamp height: 220 mm, conveyance speed: 10 m/min). At that time, conditions of irradiation with ultraviolet light were an irradiation dose of 240 mJ/cm² and an irradiation intensity of 265 mW/cm². The irradiation conditions were measured by an UV irradiation meter (“UVPF-A1” manufactured by Eye Graphics Co., Ltd.; light-receiving device PD-365 (365 nm)). By being irradiated with ultraviolet light, the layer of the liquid crystal composition was cured to obtain a liquid crystal cured film including the substrate film and the liquid crystal cured layer. The formed liquid crystal cured layer included a polymer obtained by polymerizing the polymerizable liquid crystal compound (E1) with reverse wavelength distribution, with homogeneous orientation regularity. The angle of the slow axis of the liquid crystal cured layer was confirmed to be 45° relative to the winding direction, which was the same as that of the slow axis of the substrate film used in the applying.

The liquid crystal cured film thus obtained was evaluated by the aforementioned methods.

The liquid crystal cured layer of the obtained liquid crystal cured film was transferred to a glass plate, to obtain a sample for measurement including the glass plate and the liquid crystal cured layer. Using this sample for measurement, the in-plane retardation of the liquid crystal cured layer was measured. As a result, the in-plane retardation Re(450) at a measurement wavelength of 450 nm, the in-plane retardation Re(550) at a measurement wavelength of 550 nm, and the in-plane retardation Re(650) at a measurement wavelength of 650 nm satisfied Re(450)<Re(550)<Re(650). From the result, it was confirmed that the birefringence Δn of the polymerizable liquid crystal compound (E1) with reverse wavelength distribution used in Example 1 has a property of being larger as the measurement wavelength becomes longer (reverse wavelength distribution).

### Example 2

The type of the photopolymerization initiator was changed to “IRGACURE 907” manufactured by BASF Corporation. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution, with homogeneous orientation regularity. The angle of the slow axis of the liquid crystal cured layer was confirmed to be 45° relative to the winding direction, which was the same as that of the slow axis of the substrate film used in the applying.

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Example 3

The type of the photopolymerization initiator was changed to “Lucirin TPO” manufactured by BASF Corporation. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution, with homogeneous orientation regularity. The angle of the slow axis of the liquid crystal cured layer was confirmed to be 45° relative to the winding direction, which was the same as that of the slow axis of the substrate film used in the applying.

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Example 4

80 Parts of the polymerizable liquid crystal compound (E1) with reverse wavelength distribution and 20 parts of a polymerizable liquid crystal compound with forward wavelength distribution having a structure represented by the following formula (F1) (“LC242” manufactured by BASF Corporation) were used in combination in place of 100 parts of the polymerizable liquid crystal compound (E1) with reverse wavelength distribution. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution and the polymerizable liquid crystal compound with forward wavelength distribution having the structure represented by the following formula (F1), with homogeneous orientation regularity. The angle of the slow axis of the liquid crystal cured layer was confirmed to be 45° relative to the winding direction, which was the same as that of the slow axis of the substrate film used in the applying.

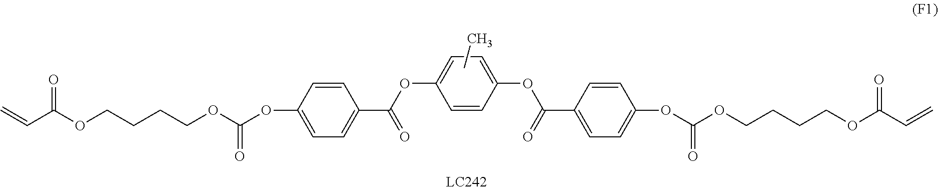

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Example 5

60 Parts of the polymerizable liquid crystal compound (E1) with reverse wavelength distribution and 40 parts of the polymerizable liquid crystal compound with forward wavelength distribution having a structure represented by the aforementioned formula (F1) (“LC242” manufactured by BASF Corporation) were used in combination in place of 100 parts of the polymerizable liquid crystal compound (E1) with reverse wavelength distribution. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution and the polymerizable liquid crystal compound with forward wavelength distribution having the structure represented by the aforementioned formula (F1), with homogeneous orientation regularity. The angle of the slow axis of the liquid crystal cured layer was confirmed to be 45° relative to the winding direction, which was the same as that of the slow axis of the substrate film used in the applying.

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Example 6

80 Parts of the polymerizable liquid crystal compound (E1) with reverse wavelength distribution and 20 parts of a polymerizable liquid crystal compound with forward wavelength distribution having a structure represented by the following formula (F2) (“LC1057” manufactured by BASF Corporation) were used in combination in place of 100 parts of the polymerizable liquid crystal compound (E1) with reverse wavelength distribution. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution and the polymerizable liquid crystal compound with forward wavelength distribution having the structure represented by the following formula (F2), with homogeneous orientation regularity. The angle of the slow axis of the liquid crystal cured layer was confirmed to be 45° relative to the winding direction, which was the same as that of the slow axis of the substrate film used in the applying.

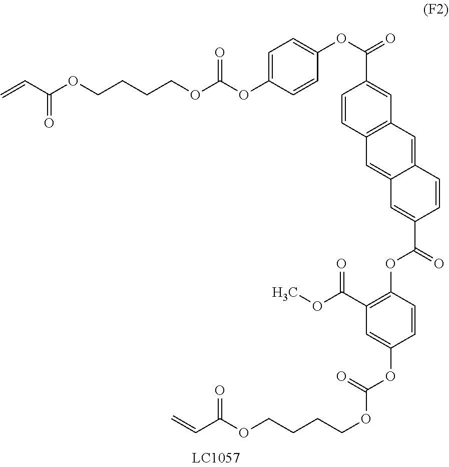 [SMILES: C=CC(=O)OCCCCOC(=O)Oc1ccc(OC(=O)c2ccc3cc4cc(C(=O)Oc5ccc(OC(=O)OCCCCOC(=O)C=C)cc5C(=O)OC)ccc4cc3c2)cc1]

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Example 7

60 Parts of the polymerizable liquid crystal compound (E1) with reverse wavelength distribution and 40 parts of the polymerizable liquid crystal compound with forward wavelength distribution having a structure represented by the aforementioned formula (F2) (“LC1057” manufactured by BASF Corporation) were used in combination in place of 100 parts of the polymerizable liquid crystal compound (E1) with reverse wavelength distribution. A liquid crystal cured film was produced and evaluated in the same manner as that of Example 1 except for the aforementioned matter. The formed liquid crystal cured layer included a polymer obtained by polymerizing the polymerizable liquid crystal compound (E1) with reverse wavelength distribution and the polymerizable liquid crystal compound with forward wavelength distribution having the structure represented by the aforementioned formula (F2), with homogeneous orientation regularity. The angle of the slow axis of the liquid crystal cured layer was confirmed to be 45° relative to the winding direction, which was the same as that of the slow axis of the substrate film used in the applying.

In the same manner as that of Example 1, the liquid crystal cured layer of the liquid crystal cured film was transferred to a glass plate to produce a sample for measurement, and the in-plane retardation of the liquid crystal cured layer was measured using the sample for measurement. As a result, the in-plane retardation of the liquid crystal cured layer satisfied Re(450)<Re(550)<Re(650).

### Comparative Example 1

Irradiation of the layer of the liquid crystal composition with ultraviolet light was performed not on the air-side surface of the layer of the liquid crystal composition but through the substrate film. A liquid crystal cured film was produced and evaluated in the same manner as that of Example 1 except for the aforementioned matter.

[Results]

Table 1 shows the compositions of the above-described Examples and Comparative Examples, and Table 2 shows the results thereof.

TABLE 1
[Compositions of Examples and Comparative Examples]

| | Polymerizable | Polymerizable | | |
|---|---|---|---|---|
| | liquid crystal | liquid crystal | | |
| | compound with | compound with | | |
| | reverse wavelength | forward wavelength | Photo | |
| | distribution | distribution | polymerization | UV |
| | (parts by weight) | (parts by weight) | initiator | exposure |
| Ex. 1 | 100 | 0 | Irg379EG | From air |
| | | | | side |
| Ex. 2 | 100 | 0 | Irg907 | From air |
| | | | | side |
| Ex. 3 | 100 | 0 | LucirinTPO | From air |
| | | | | side |
| Ex. 4 | 80 | 20 | Irg379EG | From air |
| | | | | side |
| Ex. 5 | 60 | 40 | Irg379EG | From air |
| | | | | side |
| Ex. 6 | 80 | 20 | Irg379EG | From air |
| | | | | side |
| Ex. 7 | 60 | 40 | Irg379EG | From air |
| | | | | side |
| Comp. | 100 | 0 | Irg379EG | From substrate |
| Ex. 1 | | | | side |

TABLE 2
[Results of Examples and Comparative Examples]

| | | | | | | | | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 1 |
| Air side | | | | | | | | |
| I (1) | 0.0097 | 0.0097 | 0.0111 | 0.0116 | 0.0126 | 0.0114 | 0.0133 | 0.0154 |
| I (2) | 0.0497 | 0.0498 | 0.0481 | 0.0459 | 0.0395 | 0.0437 | 0.0345 | 0.0534 |
| X (A) = | 0.20 | 0.19 | 0.23 | 0.25 | 0.32 | 0.26 | 0.39 | 0.29 |
| I (1)/I (2) | | | | | | | | |
| Substrate | | | | | | | | |
| side | | | | | | | | |
| I (1) | 0.0126 | 0.0127 | 0.0132 | 0.0135 | 0.0140 | 0.0147 | 0.0163 | 0.0106 |
| I (2) | 0.0540 | 0.0536 | 0.0547 | 0.0472 | 0.0399 | 0.0448 | 0.0359 | 0.0533 |
| X (S) = | 0.23 | 0.24 | 0.24 | 0.29 | 0.35 | 0.33 | 0.45 | 0.20 |
| I (1)/I (2) | | | | | | | | |
| X (S)/X (A) | 1.19 | 1.21 | 1.05 | 1.13 | 1.10 | 1.26 | 1.17 | 0.69 |
| Δhaze (%) | 0.36 | 0.16 | 0.15 | 0.28 | 0.22 | 0.69 | 0.21 | 1.69 |
| ΔRe (%) | −0.30 | 0.20 | −0.30 | 1.00 | 1.20 | 0.50 | 0.20 | 2.30 |
| Transferability | Good | Good | Good | Good | Good | Good | Good | Good |
| Residual | 27 | 19 | 21 | 21 | 16 | 28 | 28 | 32 |
| monomer | | | | | | | | |
| ratio | | | | | | | | |
| (%) | | | | | | | | |
| f1/f2 | 8.7 | 3.7 | 5.0 | 11.1 | 8.2 | 9.2 | 12.4 | 8.2 |

[Discussion]

As can be seen from Table 2, Examples 1 to 7 in which X(S)/X(A) satisfied the expression (i) showed small Δhaze values and improved scratch resistance. Since Examples 1 to 7 showed small absolute values of ΔRe, it can be seen that the resulting liquid crystal cured layers had excellent adhesive resistance.

### REFERENCE SIGN LIST

100 liquid crystal cured film
110 liquid crystal cured layer
120 substrate film

1. A liquid crystal cured film comprising a liquid crystal cured layer formed of a cured product of a liquid crystal composition containing a polymerizable liquid crystal compound capable of expressing birefringence with reverse wavelength distribution, the polymerizable liquid crystal compound containing an ethylenically unsaturated bond and an aromatic ring, wherein
the following expression (i) is satisfied:
1.00<X(S)/X(A) (i)
(in the expression (i),
X(S) represents a peak ratio X of one surface of the liquid crystal cured layer,
X(A) is a peak ratio X of the other surface of the liquid crystal cured layer,
the peak ratio X is a ratio represented by X=I(1)/I(2),
I(1) is a peak strength derived from in-plane deformation vibration of the ethylenically unsaturated bond in measurement of infrared total reflection-absorption spectrum, and
I(2) is a peak strength derived from stretching vibration of an unsaturated bond of the aromatic ring in measurement of infrared total reflection-absorption spectrum).

2. The liquid crystal cured film according to claim 1, wherein the liquid crystal cured layer has a retardation with reverse wavelength distribution.

3. The liquid crystal cured film according to claim, wherein
the liquid crystal composition contains a surfactant, and
an amount of the surfactant on the one surface of the liquid crystal cured layer is smaller than an amount of the surfactant on the other surface of the liquid crystal cured layer.

4. The liquid crystal cured film according to claim 1, wherein the polymerizable liquid crystal compound contains a main chain mesogen and a side chain mesogen bonded to the main chain mesogen in a molecule of the polymerizable liquid crystal compound.

5. The liquid crystal cured film according to claim 1, wherein the polymerizable liquid crystal compound is represented by the following formula (I): 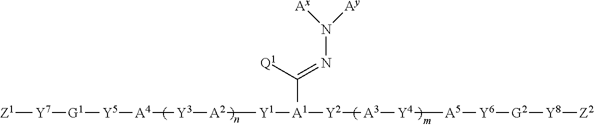
(in the formula (I),
Y¹ to Y⁸ each independently represent a chemical single bond, —O—, —S—, —O—C(═O)—, —C(═O)—O—, —O—C(═O)—O—, —NR¹—C(═O)—, —C(═O)—NR¹—, —O—C(═O)—NR¹—, —NR¹—C(═O)—O—, —NR¹—C(═O)—NR¹—, —O—NR¹—, or —NR¹—O—, where R¹ represents a hydrogen atom or an alkyl group of 1 to 6 carbon atoms,
G¹ and G² each independently represent a divalent aliphatic group of 1 to 20 carbon atoms optionally having a substituent, wherein the aliphatic group may contain one or more per aliphatic group of —O—, —S—, —O—C(═O)—, —C(═O)—O—, —O—C(═O)—O—, —NR²—C(═O)—, —C(═O)— NR²—, —NR²—, or —C(═O)— inserted therein, with a proviso that cases where two or more —O— or —S— groups are inserted adjacently to each other are excluded, and wherein R² represents an alkyl group of 1 to 6 carbon atoms,
Z¹ and Z² each independently represent an alkenyl group of 2 to 10 carbon atoms optionally substituted with a halogen atom,
A^{x} represents an organic group of 2 to 30 carbon atoms having at least one aromatic ring selected from the group consisting of an aromatic hydrocarbon ring and an aromatic heterocyclic ring,
A^{y} represents a hydrogen atom, an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, an alkynyl group of 2 to 20 carbon atoms optionally having a substituent, —C(═O)—R³, —SO₂—R⁴, —C(═S)NH—R⁹, or an organic group of 2 to 30 carbon atoms containing at least one aromatic ring selected from the group consisting of an aromatic hydrocarbon ring and an aromatic heterocyclic ring, where R³ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic hydrocarbon ring group of 5 to 12 carbon atoms, R⁴ represents an alkyl group of 1 to 20 carbon atoms, an alkenyl group of 2 to 20 carbon atoms, a phenyl group, or a 4-methylphenyl group, R⁹ represents an alkyl group of 1 to 20 carbon atoms optionally having a substituent, an alkenyl group of 2 to 20 carbon atoms optionally having a substituent, a cycloalkyl group of 3 to 12 carbon atoms optionally having a substituent, or an aromatic group of 5 to 20 carbon atoms optionally having a substituent, the aromatic ring contained in the A^{x} and A^{y} may have a substituent, and the A^{x} and A^{y} may form a ring together,
A¹ represents a trivalent aromatic group optionally having a substituent,
A² and A³ each independently represent a divalent alicyclic hydrocarbon group of 3 to 30 carbon atoms optionally having a substituent,
A⁴ and A⁵ each independently represent a divalent aromatic group of 6 to 30 carbon atoms optionally having a substituent,
Q¹ represents a hydrogen atom or an alkyl group of 1 to 6 carbon atoms optionally having a substituent, and
m and n each independently represent 0 or 1).

6. The liquid crystal cured film according to claim 1, wherein the polymerizable liquid crystal compound contains at least one selected from the group consisting of a benzothiazole ring, and a combination of a cyclohexyl ring and a phenyl ring, in a molecule of the polymerizable liquid crystal compound.

7. A method for producing the liquid crystal cured firm according to claim 1, comprising the steps of:
forming a layer of the liquid crystal composition on a substrate film; and
curing the layer of the liquid crystal composition to obtain the liquid crystal cured layer.
